(19) United States
(12) Patent Application Publication
(10) Pub. No.: US 2007/0286969 A1
(43) Pub. Date: Dec. 13, 2007

(54) POLARIZING OPTICAL ELEMENTS AND METHOD FOR PREPARING POLYURETHANE-CONTAINING FILMS

(75) Inventors: Vidhu J. Nagpal, Murrysville, PA (US); Anil Kumar, Murrysville, PA (US); Carol L. Knox, Monroeville, PA (US); Yingchao Zhang, Murrysville, PA (US); Peter C. Foller, Murrysville, PA (US)

Correspondence Address: Deborah M. Altman;PPG Industries, Inc., Law Department - Intellectual Property, One PPG Place - 39th Floor, Pittsburgh, PA, 15272-0001, US

(73) Assignee: PPG INDUSTRIES OHIO, INC., Cleveland, OH (US)

(21) Appl. No.: 11/759,299

(22) Filed: Jun. 7, 2007

Related U.S. Application Data
(60) Provisional application No. 60/811,906, filed on Jun. 8, 2006.

(51) Int. Cl. C09K 19/00

(52) U.S. Cl. 428/1.31

(57) ABSTRACT

Described is a method of preparing a cured, non-elastomeric polyurethane-containing film including: a) providing as a first component comprising a polyurethane material having isocyanate functional groups; b) providing as a second component a material having active hydrogen-containing functional groups that are reactive with isocyanate; c) combining the first and second components to form a reaction mixture; d) casting the reaction mixture onto a support substrate in a substantially uniform thickness to form a film thereon; e) heating the film on the support substrate to a temperature and for a time sufficient to yield a cured film; and f) removing the cured film from the support substrate to yield a non-elastomeric polyurethane-containing free film. The free film is non-birefringent. Optical elements and articles prepared from the films are also provided.

### CROSS-REFERENCE TO RELATED APPLICATIONS

This application claims the benefit of priority from U.S. Provisional Patent Application No. 60/811,906, filed Jun. 8, 2006.

### FIELD OF THE INVENTION

The present invention relates to polarizing optical elements and articles and a method of preparing a cured, non-elastomeric polyurethane-containing film.

### BACKGROUND OF THE INVENTION

Polarizing optical elements that provide acceptable imaging qualities while maintaining durability and abrasion resistance are sought for a variety of applications, such as displays, screens, windshields, sunglasses, fashion lenses, non-prescription and prescription lenses, sport masks, face shields and goggles.

Conventional polarizing filters are formed from sheets or layers of a polymeric material such as polyvinyl alcohol that has been stretched or otherwise oriented and impregnated with an iodine chromophore or dichroic dye. Typically these impregnated sheets are layered between supporting films of cellulose triacetate or polyethylene terephthalate, which have good optical properties.

Polyurethane-containing materials such as polyurethane-ureas have been developed as useful polymers in the manufacture of optical articles because of their excellent properties such as low birefringence, resilience, and chemical and impact resistance. They typically have been used in mold castings for lenses, glazings, and the like. Their use heretofore has been limited to these applications because of difficulties in preparing films of polyurethane-containing polymers. Such difficulties can include low gel time and high viscosity, making conventional film casting of these materials very difficult due to poor workability.

Birefringence, or “double refraction”, in [polymeric films can be caused by the orientation of polymers during the film manufacturing operations. The molecular orientation of the polymers may lead to significantly different indices of refraction within the plane of the film. Birefringence is the difference between these indices of refraction in perpendicular directions within the plane of the film. Optical materials with low or negligible birefringence are desirable in certain optical articles, in particular, in combination with polarizing filters.

It would be desirable to provide a method of preparing polyurethane-containing materials in free films, for use as film layers in optical elements and other articles, so as to take advantage of their superior optical and mechanical properties.

### SUMMARY OF THE INVENTION

In accordance with the present invention, a method of preparing a cured, non-elastomeric polyurethane-containing free film is provided. The method comprises:

a) providing a first component comprising a polyurethane material having isocyanate functional groups;

b) providing a second component comprising a material having active hydrogen-containing functional groups that are reactive with isocyanate;

c) combining the first and second components to form a reaction mixture;

d) casting the reaction mixture onto a support substrate in a substantially uniform thickness to form a film thereon;

e) heating the film on the support substrate to a temperature and for a time sufficient to yield a cured film; and

f) removing the cured film from the support substrate to yield a non-elastomeric polyurethane-containing free film, which is non-birefringent. The cured, non-elastomeric polyurethane-containing free films prepared by the method of the present invention provide excellent temperature and chemical resistance; and are compatible with a wide variety of polymeric films and coatings.

Further the present invention is directed to a polarizing optical element comprising in combination:

a) a polarizing film layer having two opposed surfaces; and

b) a protective, supportive layer comprising a cured, non-elastomeric polyurethane-containing film appended to at least one of the opposed surfaces of the polarizing layer.

Additionally, the present invention provides an optical article. The optical article comprises, in combination:

a) a substrate; and

b) a polarizing optical element appended to the substrate, in turn comprising, in combination:
i) a polarizing film layer having two opposed surfaces; and
ii) a protective, supportive layer comprising a cured, non-elastomeric polyurethane-containing free film appended to at least one of the opposed surfaces of the polarizing layer. The optical article of the present invention may comprise a display, screen, lens, windshield, ophthalmic article, or glazing, and the optical article is particularly suitable as a component of a liquid crystal display.

### BRIEF DESCRIPTION OF THE DRAWINGS

FIG. 1 is an illustration of a cross section of a polarizing optical element in accordance with one embodiment of the present invention.

FIG. 2 is an illustration of a particular embodiment of a polarizing optical element in accordance with the present invention.

FIG. 3 is an illustration of a cross section of an optical article in accordance with the present invention; in particular, it is an illustration of a cross section, exploded view, of a liquid crystal display.

### DETAILED DESCRIPTION OF THE INVENTION

It is noted that, as used in this specification and the appended claims, the singular forms “a,” “an,” and “the” include plural referents unless expressly and unequivocally limited to one referent.

For the purposes of this specification, unless otherwise indicated, all numbers expressing quantities of ingredients, reaction conditions, and other parameters used in the specification and claims are to be understood as being modified in all instances by the term “about.” Accordingly, unless indicated to the contrary, the numerical parameters set forth in the following specification and attached claims are approximations that may vary depending upon the desired properties to be obtained by the present invention. At the very least, and not as an attempt to limit the application of the doctrine of equivalents to the scope of the claims, each numerical parameter should at least be construed in light of the number of reported significant digits and by applying ordinary rounding techniques.

All numerical ranges herein include all numerical values and ranges of all numerical values within the recited numerical ranges. Notwithstanding that the numerical ranges and parameters setting forth the broad scope of the invention are approximations, the numerical values set forth in the specific examples are reported as precisely as possible. Any numerical value, however, inherently contain certain errors necessarily resulting from the standard deviation found in their respective testing measurements.

The various embodiments and examples of the present invention as presented herein are each understood to be non-limiting with respect to the scope of the invention.

As used in the following description and claims, the following terms have the indicated meanings:

The terms “acrylic” and “acrylate” are used interchangeably (unless to do so would alter the intended meaning) and include acrylic acids, anhydrides, and derivatives thereof, such as their C₁-C₅ alkyl esters, lower alkyl-substituted acrylic acids, e.g., C₁-C₅ substituted acrylic acids, such as methacrylic acid, ethacrylic acid, etc., and their C₁-C₅ alkyl esters, unless clearly indicated otherwise. The terms “(meth)acrylic” or “(meth)acrylate” are intended to cover both the acrylic/acrylate and methacrylic/methacrylate forms of the indicated material, e.g., a (meth)acrylate monomer.

The term “cure”, “cured” or similar terms, as used in connection with a cured or curable composition, e.g., a “cured composition” of some specific description, means that at least a portion of the polymerizable and/or crosslinkable components that form the curable composition is at least partially polymerized and/or crosslinked. The term “curable”, as used for example in connection with a curable film-forming composition, means that the indicated composition is polymerizable or cross linkable, e.g., by means that include, but are not limited to, thermal, catalytic, electron beam, chemical free-radical initiation, and/or photoinitiation such as by exposure to ultraviolet light or other actinic radiation. In the context of the present invention, a “cured” composition may continue to be further curable depending on the availability of polymerizable or crosslinkable components.

The term “non-elastomeric” refers to materials that do not exhibit typical elastomeric behavior; i.e., they do not readily undergo reversible deformation or elongation to at least twice their original length.

The term “light influencing function”, “light influencing property” or terms of like import means that the indicated material, e.g., coating, film, substrate, etc., is capable of modifying by absorption (or filtering) of incident light radiation, e.g., visible, ultraviolet (UV) and/or infrared (IR) radiation that impinges on the material. In alternate embodiments, the light influencing function can be light polarization, e.g., by means of a polarizer and/or dichroic dye; a change in light absorption properties, e.g., by use of a chromophore that changes color upon exposure to actinic radiation, such as a photochromic material; transmission of only a portion of the incident light radiation, e.g., by use of a fixed tint such as a conventional dye; or by a combination of one or more of such light influencing functions.

The term “adapted to possess at least one light influencing property”, as used for example in connection with a rigid optical substrate, means that the specified item is capable of having the light influencing property incorporated into or appended to it. For example, a plastic or polymer matrix that is adapted to possess a light influencing property means that the matrix has sufficient internal free volume to accommodate internally a photochromic dye or tint. The surface of such a plastic matrix may alternatively be capable of having a photochromic or tinted layer, film or coating appended to it, and/or is capable of having a polarizing film appended to it.

The terms “on”, “appended to”, “affixed to”, “bonded to”, “adhered to”, or like terms means that the designated item, e.g., a coating, film or layer, is either directly connected to (superimposed on) the object or substrate surface, or indirectly connected to the object or substrate surface, e.g., through one or more other coatings, films or layers (superposed on).

The term “ophthalmic” refers to elements and devices that are associated with the eye and vision, such as but not limited to, lenses for eyewear, e.g., corrective and non-corrective lenses, and magnifying lenses.

The term “optical quality”, as used for example in connection with polymeric materials, e.g., a “resin of optical quality” or “organic polymeric material of optical quality” means that the indicated material, e.g., a polymeric material, resin, or resin composition, is or forms a substrate, layer, film or coating that can be used as an optical article, such as an ophthalmic lens, or in combination with an optical article, because of its suitable optical properties.

The term “rigid”, as used for example in connection with an optical substrate, means that the specified item is self-supporting.

The term “optical substrate” means that the specified substrate exhibits a light transmission value (transmits incident light) of at least 4 percent and exhibits a haze value of less than 5 percent, e.g., less than 1 percent, (depending on the thickness of the substrate) when measured at 550 nanometers by, for example, a Haze Gard Plus Instrument. Optical substrates include, but are not limited to, optical articles such as lenses, optical layers, e.g., optical resin layers, optical films and optical coatings, and optical substrates having a light influencing property.

The term “photochromic receptive” means that the indicated item has sufficient free volume to permit photochromic material(s) incorporated within it to transform from its colorless form to its colored form (and then revert to its colorless form) to the degree required for commercial optical applications.

The term “tinted”, as used for example in connection with ophthalmic elements and optical substrates, means that the indicated item contains a fixed light radiation absorbing agent, such as but not limited to, conventional coloring dyes, infrared and/or ultraviolet light absorbing materials on or in the indicated item. The tinted item has an absorption spectrum for visible radiation that does not vary significantly in response to actinic radiation.

The term “non-tinted”, as used for example in connection with ophthalmic elements and optical substrates, means that the indicated item is substantially free of fixed light radiation absorbing agents. The non-tinted item has an absorption spectrum for visible radiation that does not vary significantly in response to actinic radiation.

The term “actinic radiation” includes light with wavelengths of electromagnetic radiation ranging from the ultraviolet (“UV”) light range, through the visible light range, and into the infrared range. Actinic radiation which can be used to cure coating compositions used in the present invention generally has wavelengths of electromagnetic radiation ranging from 150 to 2,000 nanometers (nm), from 180 to 1,000 nm, or from 200 to 500 nm. In one embodiment, ultraviolet radiation having a wavelength ranging from 10 to 390 nm can be used. Examples of suitable ultraviolet light sources include mercury arcs, carbon arcs, low, medium or high pressure mercury lamps, swirl-flow plasma arcs and ultraviolet light emitting diodes. Suitable ultraviolet light-emitting lamps are medium pressure mercury vapor lamps having outputs ranging from 200 to 600 watts per inch (79 to 237 watts per centimeter) across the length of the lamp tube.

The term “tinted photochromic”, as used for example in connection with ophthalmic elements and optical substrates, means that the indicated item contains a fixed light absorbing agent and a photochromic material. The indicated item has an absorption spectrum for visible radiation that varies in response to actinic radiation and is thermally reversible when the actinic radiation is removed. For example, the tinted photochromic item may have a first characteristic of the light absorbing agent, e.g., a coloring tint, and a second color characteristic of the combination of the light absorbing agent and the activated photochromic material when the photochromic material is exposed to actinic radiation.

The term “dichroic material”, “dichroic dye” or like terms means a material/dye that absorbs one of two orthogonal plane-polarized components of transmitted radiation more strongly than the other. Non-limiting examples of dichroic materials include indigoids, thioindigoids, merocyanines, indans, azo and poly(azo) dyes, benzoquinones, naphthoquinones, anthraquinones, (poly)anthraquinones, anthrapyrimidinones, iodine and iodates. The term “dichroic” is synonymous with “polarizing” or words of like import.

The term “dichroic photochromic” means a specified material or article that exhibits both dichroic and photochromic properties. In alternate non-limiting embodiments, the specified material can include both photochromic dyes/compounds and dichroic dyes/compounds, or single dyes/compounds that possess both photochromic and dichroic properties.

The term “transparent”, as used for example in connection with a substrate, film, material and/or coating, means that the indicated substrate, coating, film and/or material has the property of transmitting light without appreciable scattering so that objects lying beyond are entirely visible.

The phrase “an at least partial film” means an amount of film covering at least a portion, up to the complete surface of the substrate. A “film” is defined as a thin, substantially continuous layer of material that may be formed by a sheeting type of material or a coating type of material. As used herein, a “free film” comprises an article of self-sufficient structural integrity;that is, a thin sheet that is not necessarily in contact with and does not require a supporting substrate.

The term “photochromic amount” means that a sufficient amount of photochromic material is used to produce a photochromic effect discernible to the naked eye upon activation. The particular amount used depends often upon the intensity of color desired upon irradiation thereof and upon the method used to incorporate the photochromic materials. Typically, in another non-limiting embodiment, the more photochromic incorporated, the greater is the color intensity up to a certain limit. There is a point after which the addition of any more material will not have a noticeable effect, although more material can be added, if desired.

The term “superposed” describes a coating or film applied on top of or subsequent to another specified layer in a layered article.

As previously mentioned, the present invention is directed to a method of preparing a cured, non-elastomeric polyurethane-containing free film. The method comprises:

a) providing a first component comprising a polyurethane material having isocyanate functional groups;

b) providing a second component comprising a material having active hydrogen-containing functional groups that are reactive with isocyanate;

c) combining the first and second components to form a reaction mixture;

d) casting the reaction mixture onto a support substrate in a substantially uniform thickness to form a film thereon;

e) heating the film on the support substrate to a temperature and for a time sufficient to yield a cured film; and

f) removing the cured film from the support substrate to yield a non-elastomeric polyurethane-containing free film. The free film is non-birefringent. In certain embodiments, depending on the materials used to prepare the polyurethane-containing material, the free film may demonstrate a stress at break of at least 9000 psi, and a strain at break of at least 70 percent.

Suitable polyurethane materials having isocyanate functional groups for use in the first component may include polyurethane prepolymers derived from (a) polyisocyanates and (b) materials having active hydrogen-containing groups that are reactive with isocyanates.

Polyisocyanates useful in the preparation of the polyurethane material in the first component are numerous and widely varied. Non-limiting examples can include aliphatic polyisocyanates, cycloaliphatic polyisocyanates wherein one or more of the isocyanato groups are attached directly to the cycloaliphatic ring, cycloaliphatic polyisocyanates wherein one or more of the isocyanato groups are not attached directly to the cycloaliphatic ring, aromatic polyisocyanates wherein one or more of the isocyanato groups are attached directly to the aromatic ring, and aromatic polyisocyanates wherein one or more of the isocyanato groups are not attached directly to the aromatic ring, and mixtures thereof. For some applications, care should be taken to select a material that does not cause the polyurethane-containing to color (e.g., yellow).

The polyisocyanate can include but is not limited to aliphatic or cycloaliphatic diisocyanates, aromatic diisocyanates, cyclic dimers and cyclic trimers thereof, and mixtures thereof. Non-limiting examples of suitable polyisocyanates can include DESMODUR N 3300 (hexamethylene diisocyanate trimer) which is commercially available from Bayer; DESMODUR N 3400 (60% hexamethylene diisocyanate dimer and 40% hexamethylene diisocyanate trimer). In a non-limiting embodiment, the polyisocyanate can include dicyclohexylmethane diisocyanate and isomeric mixtures thereof. As used herein and the claims, the term “isomeric mixtures” refers to a mixture of the cis-cis, trans-trans, and/or cis-trans isomers of the polyisocyanate. Non-limiting examples of isomeric mixtures for use in the present invention can include the trans-trans isomer of 4,4′-methylenebis(cyclohexyl isocyanate), hereinafter referred to as “PICM” (paraisocyanato cyclohexylmethane), the cis-trans isomer of PICM, the cis-cis isomer of PICM, and mixtures thereof.

Suitable isomers for use in the present invention include but are not limited to the following three isomers of 4,4′-methylenebis(cyclohexyl isocyanate).

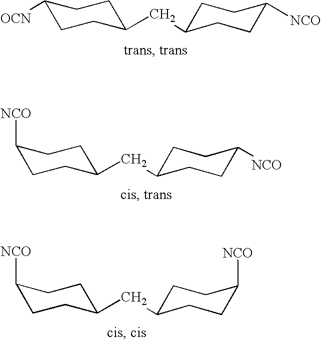

PICM can be prepared by phosgenating 4,4′-methylenebis(cyclohexyl amine) (PACM) by procedures well known in the art such as the procedures disclosed in U.S. Pat. Nos. 2,644,007; 2,680,127 and 2,908,703; which are incorporated herein by reference. The PACM isomer mixtures, upon phosgenation, can produce PICM in a liquid phase, a partially liquid phase, or a solid phase at room temperature. Alternatively, the PACM isomer mixtures can be obtained by the hydrogenation of methylenedianiline and/or by fractional crystallization of PACM isomer mixtures in the presence of water and alcohols such as methanol and ethanol.

Additional aliphatic and cycloaliphatic diisocyanates that can be used include 3-isocyanato-methyl-3,5,5-trimethyl cyclohexyl-isocyanate (“I PDlI”) which is commercially available from Arco Chemical, and meta-tetramethylxylene diisocyanate (1,3-bis(1-isocyanato-1-methylethyl)-benzene) which is commercially available from Cytec Industries Inc. under the trade name TMXDI® (Meta) Aliphatic Isocyanate.

As used herein and the claims, the term “aliphatic and cycloaliphatic diisocyanates” refers to 6 to 100 carbon atoms linked in a straight chain or cyclized having two diisocyanate reactive end groups. In a non-limiting embodiment of the present invention, the aliphatic and cycloaliphatic diisocyanates for use in the present invention can include TMXDI and compounds of the formula R-(NCO)₂ wherein R represents an aliphatic group or a cycloaliphatic group.

The material (b) comprising active hydrogen-containing groups, used to prepare the polyurethane materials of the first component, may be any compound or mixture of compounds that contain hydroxyl (OH) groups and, if desired, other active hydrogen groups reactive with isocyanate (e.g. amino groups) and/or thiol groups. The material (b) may comprise a compound having at least two active hydrogen-containing groups comprising OH groups and primary amine groups, secondary amine groups, thiol groups, and/or combinations thereof. A single polyfunctional compound having OH groups may be used; or a single polyfunctional compound having mixed functional groups may be used, or a mixture may be used. Several different compounds may be used in admixture having the same or different functional groups; e.g., two different polyamines may be used, polythiols mixed with polyamines may be used, or polyamines mixed with hydroxyl functional polythiols, for example, are suitable.

Suitable OH-containing materials for use in the present invention in the preparation of the polyurethane material in the first component can include but are not limited to polyether polyols, polyester polyols, polycaprolactone polyols, polycarbonate polyols, and mixtures thereof.

Examples of polyether polyols are polyalkylene ether polyols which can include those having the following structural formula: 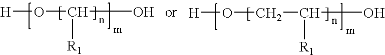
where the substituent R1 is hydrogen or lower alkyl containing from 1 to 5 carbon atoms including mixed substituents, and n is typically from 2 to 6 and m is from 8 to 100 or higher. Included are poly(oxytetramethylene) glycols, poly(oxytetraethylene) glycols, poly(oxy-1,2-propylene) glycols, and poly(oxy-1,2-butylene) glycols. Non-limiting examples of alkylene oxides can include ethylene oxide, propylene oxide, butylene oxide, amylene oxide, aralkylene oxides, such as but not limited to styrene oxide, mixtures of ethylene oxide and propylene oxide. In a further non-limiting embodiment, polyoxyalkylene polyols can be prepared with mixtures of alkylene oxide using random or step-wise oxyalkylation.

Also useful are polyether polyols formed from oxyalkylation of various polyols, for example, diols such as ethylene glycol, 1,6-hexanediol, Bisphenol A and the like, or other higher polyols such as trimethylolpropane, pentaerythritol, and the like. Polyols of higher functionality which can be utilized as indicated can be made, for instance, by oxyalkylation of compounds such as sucrose or sorbitol. One commonly utilized oxyalkylation method is reaction of a polyol with an alkylene oxide, for example, propylene or ethylene oxide, in the presence of an acidic or basic catalyst. Particular polyethers include those sold under the names TERATHANE and TERACOL, available from E. I. Du Pont de Nemours and Company, Inc., and POLYMEG, available from Q O Chemicals, Inc., a subsidiary of Great Lakes Chemical Corp.

Polyether glycols for use in the present invention can include but are not limited to polytetramethylene ether glycol.

The polyether-containing polyol can comprise block copolymers including blocks of ethylene oxide-propylene oxide and/or ethylene oxide-butylene oxide. PLURONIC R, PLURONIC L62D, TETRONIC R and TETRONIC, which are commercially available from BASF, can be used as the polyether-containing polyol material in the present invention.

Suitable polyester glycols can include but are not limited to the esterification products of one or more dicarboxylic acids having from four to ten carbon atoms, such as adipic, succinic or sebacic acids, with one or more low molecular weight glycols having from two to ten carbon atoms, such as ethylene glycol, propylene glycol, diethylene glycol, 1,4-butanediol, neopentyl glycol, 1,6-hexanediol and 1,10-decanediol. In a non-limiting embodiment, the polyester glycols can be the esterification products of adipic acid with glycols of from two to ten carbon atoms.

Suitable polycaprolactone glycols for use in the present invention can include the reaction products of E-caprolactone with one or more of the low molecular weight glycols listed above. A polycaprolactone may be prepared by condensing caprolactone in the presence of a difunctional active hydrogen compound such as water or at least one of the low molecular weight glycols listed above. Particular examples of polycaprolactone glycols include polycaprolactone polyesterdiols available as CAPA® 2047 and CAPA® 2077 from Solvay Corp.

Polycarbonate polyols are known in the art and are commercially available such as Ravecarb™ 107 (Enichem S.p.A.). In a non-limiting embodiment, the polycarbonate polyol can be produced by reacting an organic glycol such as a diol and a dialkyl carbonate, such as described in U.S. Pat. No. 4,160,853. In a non-limiting embodiment, the polyol can include polyhexamethyl carbonate having varying degrees of polymerization.

The glycol material can comprise low molecular weight polyols such as polyols having a molecular weight of less than 500, and compatible mixtures thereof. As used herein, the term “compatible” means that the glycols are mutually soluble in each other so as to form a single phase. Non-limiting examples of these polyols can include low molecular weight diols and triols. If used, the amount of triol is chosen so as to avoid a high degree of cross-linking in the polyurethane. A high degree of cross-linking can result in a curable polyurethane that is not formable by moderate heat and pressure. The organic glycol typically contains from 2 to 16, or from 2 to 6, or from 2 to 10, carbon atoms. Non-limiting examples of such glycols can include ethylene glycol, propylene glycol, diethylene glycol, triethylene glycol, tetraethylene glycol, dipropylene glycol, tripropylene glycol, 1,2-, 1,3-and 1,4-butanediol, 2,2,4-trimethyl-1,3-pentanediol, 2-methyl- 1,3-pentanediol, 1,3-2,4-and 1,5-pentanediol, 2,5-and 1,6-hexanediol, 2,4-heptanediol, 2-ethyl-1,3-hexanediol, 2,2-dimethyl-1,3-propanediol, 1,8-octanediol, 1,9-nonanediol, 1,10-decanediol, 1,4-cyclohexanediol, 1,4-cyclohexanedimethanol, 1,2-bis(hydroxyethyl)-cyclohexane, glycerin, tetramethylolmethane, such as but not limited to pentaerythritol, trimethylolethane and trimethylolpropane; and isomers thereof.

The OH-containing material can have a weight average molecular weight, for example, of at least 60, such as at least 90, or at least 200. Additionally, the OH-containing material can have a weight average molecular weight, for example, of less than 10,000, such as less than 7000, or less than 5000, or less than 2000.

The OH-containing material for use in the present invention can include teresters produced from at least one low molecular weight dicarboxylic acid, such as adipic acid.

Polyester glycols and polycaprolactone glycols for use in the present invention can be prepared using known esterification or transesterification procedures as described, for example, in the article D. M. Young, F. Hostettler et al., “Polyesters from Lactone,” Union Carbide F-40, p. 147.

Polyester glycols can also be prepared from the reaction of 1,6-hexanediol and adipic acid; 1,10-decandiol and adipic acid; or 1,10-decanediol and caprolactone.

In alternate non-limiting embodiments, the OH-containing material for use in the present invention can be chosen from: (a) esterification product of adipic acid with at least one diol selected from 1,4-butanediol, 1,6-hexanediol, neopentyl glycol, or 1,10-decanediol; (b) reaction product of E-caprolactone with at least one diol selected from 1,4-butane diol, 1,6-hexane diol, neopentyl glycol, or 1,10-decanediol; (c) polytetramethylene glycol; (d) aliphatic polycarbonate glycols, and (e) mixtures thereof.

Thiol-containing materials may be used to produce a prepolymer such as a sulfur-containing isocyanate-functional polyurethane for the preparation of high index polyurethane-containing films; i.e., films having a relatively high refractive index. Note that in these embodiments the polyurethane prepolymer used as the first component may contain disulfide linkages due to disulfide linkages contained in the polythiol and/or polythiol oligomer used to prepare the polyurethane prepolymer.

Thiol-containing materials may have at least two thiol functional groups and may comprise a dithiol, a compound having more than two thiol functional groups, or a mixture of a dithiol and a compound having more than two thiol functional groups (higher polythiol). Such mixtures may include mixtures of dithiols and/or mixtures of higher polythiols. The thiol functional groups are typically terminal groups, though a minor portion (i.e., less than 50 percent of all groups) may be pendant along a chain. The compound (a) may additionally contain a minor portion of other active hydrogen functionality (i.e., different from thiol), for example, hydroxyl functionality. Thiol-containing materials may be linear or branched, and may contain cyclic, alkyl, aryl, aralkyl, or alkaryl groups.

Thiol-containing materials may be selected so as to produce a substantially linear oligomeric polythiol. Therefore, when the material comprises a mixture of a dithiol and a compound having more than two thiol functional groups, the compound having more than two thiol functional groups can be present in an amount up to 10 percent by weight of the mixture.

Suitable dithiols can include linear or branched aliphatic, cycloaliphatic, aromatic, heterocyclic, polymeric, oligomeric dithiols and mixtures thereof. The dithiol can comprise a variety of linkages including but not limited to ether linkages (—O—), sulfide linkages (—S—), polysulfide linkages (—Sₓ—, wherein x is at least 2, or from 2 to 4) and combinations of such linkages.

Non-limiting examples of suitable dithiols for use in the present invention can include but are not limited to 2,5-dimercaptomethyl-1,4-dithiane, dimercaptodiethylsulfide (DMDS), ethanedithiol, 3,6-dioxa-1,8-octanedithiol, ethylene glycol di(2-mercaptoacetate), ethylene glycol di(3-mercaptopropionate), poly(ethylene glycol) di(2-mercaptoacetate) and poly(ethylene glycol) di(3-mercaptopropionate), benzenedithiol, 4-tert-butyl-1,2-benzenedithiol, 4,4′-thiodibenzenethiol, and mixtures thereof.

The dithiol may include dithiol oligomers having disulfide linkages such as materials represented by the following formula: 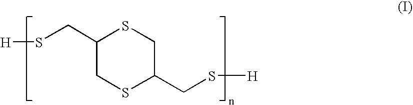
wherein n can represent an integer from 1 to 21.

Dithiol oligomers represented by Formula 1 can be prepared, for example, by the reaction of 2,5-dimeracaptomethyl-1,4-dithiane with sulfur in the presence of basic catalyst, as known in the art.

The nature of the SH group in polythiols is such that oxidative coupling can occur readily, leading to formation of disulfide linkages. Various oxidizing agents can lead to such oxidative coupling. The oxygen in the air can in some cases lead to such oxidative coupling during storage of the polythiol. It is believed that a possible mechanism for the oxidative coupling of thiol groups involves the formation of thiyl radicals, followed by coupling of said thiyl radicals, to form disulfide linkage. It is further believed that formation of disulfide linkage can occur under conditions that can lead to the formation of thiyl radical, including but not limited to reaction conditions involving free radical initiation. The polythiols for use as compound (a) in the preparation of the polythiols of the present invention can include species containing disulfide linkages formed during storage.

The polythiols for use in material (b) in the preparation of the polyurethane material in the first component can also include species containing disulfide linkages formed during synthesis of the polythiol.

In certain embodiments, the dithiol for use in the present invention, can include at least one dithiol represented by the following structural formulas:

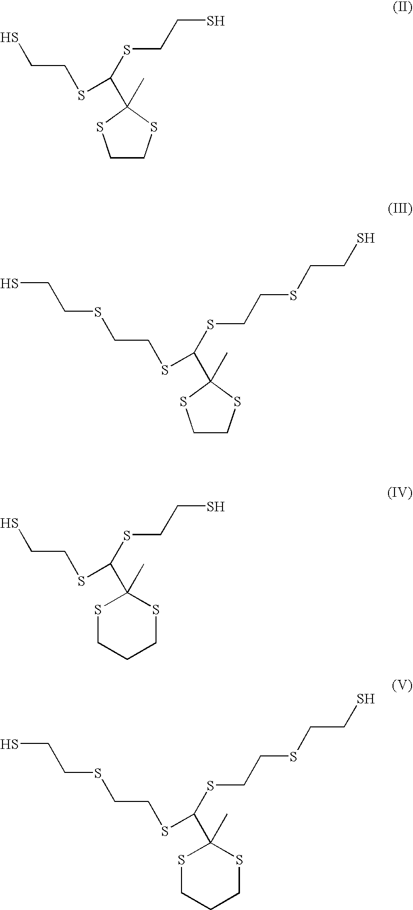

The sulfide-containing dithiols comprising 1,3-dithiolane (e.g., formulas II and III) or 1,3-dithiane (e.g., formulas IV and V) can be prepared by reacting asym-dichloroacetone with dimercaptan, and then reacting the reaction product with dimercaptoalkylsulfide, dimercaptan or mixtures thereof, as described in U.S. Pat. No. 7,009,032 B2.

Non-limiting examples of suitable dimercaptans for use in the reaction with asym-dichloroacetone can include but are not limited to materials represented by the following formula: 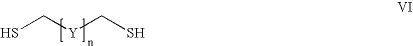
wherein Y can represent CH₂ or (CH₂—S—CH₂), and n can be an integer from 0 to 5. The dimercaptan for reaction with asym-dichloroacetone in the present invention can be chosen from, for example, ethanedithiol, propanedithiol, and mixtures thereof.

The amount of asym-dichloroacetone and dimercaptan suitable for carrying out the above reaction can vary. For example, asym-dichloroacetone and dimercaptan can be present in the reaction mixture in an amount such that the molar ratio of dichloroacetone to dimercaptan can be from 1:1 to 1:10.

Suitable temperatures for reacting asym-dichloroacetone with dimercaptan can vary, often ranging from 0 to 100° C.

Non-limiting examples of suitable dimercaptans for use in the reaction with the reaction product of the asym-dichloroacetone and dimercaptan, can include but are not limited to materials represented by the above general formula VI, aromatic dimercaptans, cycloalkyl dimercaptans, heterocyclic dimercaptans, branched dimercaptans, and mixtures thereof.

Non-limiting examples of suitable dimercaptoalkylsulfides for use in the reaction with the reaction product of the asym-dichloroacetone and dimercaptan, can include materials represented by the following formula: 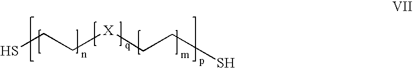
wherein X can represent O, S or Se, n can be an integer from 0 to 10, m can be an integer from 0 to 10, p can be an integer from 1 to 10, q can be an integer from 0 to 3, and with the proviso that (m+n) is an integer from 1 to 20.

Non-limiting examples of suitable dimercaptoalkylsulfides for use in the present invention can include branched dimercaptoalkylsulfides.

The amount of dimercaptan, dimercaptoalkylsulfide, or mixtures thereof, suitable for reacting with the reaction product of asym-dichloroacetone and dimercaptan, can vary. Typically, dimercaptan, dimercaptoalkylsulfide, or a mixture thereof, can be present in the reaction mixture in an amount such that the equivalent ratio of reaction product to dimercaptan, dimercaptoalkylsulfide, or a mixture thereof, can be from 1:1.01 to 1:2. Moreover, suitable temperatures for carrying out this reaction can vary within the range of from 0 to 100° C.

The reaction of asym-dichloroacetone with dimercaptan can be carried out in the presence of an acid catalyst. The acid catalyst can be selected from a wide variety known in the art, such as but not limited to Lewis acids and Bronsted acids. Non-limiting examples of suitable acid catalysts can include those described in Ullmann's Encyclopedia of Industrial Chemistry, 5^{th} Edition, 1992, Volume A21, pp. 673 to 674. The acid catalyst is often chosen from boron trifluoride etherate, hydrogen chloride, toluenesulfonic acid, and mixtures thereof. The amount of acid catalyst can vary from 0.01 to 10 percent by weight of the reaction mixture.

The reaction product of asym-dichloroacetone and dimercaptan can alternatively be reacted with dimercaptoalkylsulfide, dimercaptan or mixtures thereof, in the presence of a base. The base can be selected from a wide variety known in the art, such as but not limited to Lewis bases and Bronsted bases. Non-limiting examples of suitable bases can include those described in Ullmann's Encyclopedia of Industrial Chemistry, 5^{th} Edition, 1992, Volume A21, pp. 673 to 674. The base is often sodium hydroxide. The amount of base can vary. Typically, a suitable equivalent ratio of base to reaction product of the first reaction, can be from 1:1 to 10:1.

The reaction of asym-dichloroacetone with dimercaptan can be carried out in the presence of a solvent. The solvent can be selected from but is not limited to organic solvents. Non-limiting examples of suitable solvents can include but are not limited to chloroform, dichloromethane, 1,2-dichloroethane, diethyl ether, benzene, toluene, acetic acid and mixtures thereof.

In another embodiment, the reaction product of asym-dichloroacetone and dimercaptan can be reacted with dimercaptoalkylsulfide, dimercaptan or mixtures thereof, with or without the presence of a solvent, wherein the solvent can be selected from but is not limited to organic solvents. Non-limiting examples of suitable organic solvents can include alcohols such as but not limited to methanol, ethanol and propanol; aromatic hydrocarbon solvents such as but not limited to benzene, toluene, xylene; ketones such as but not limited to methyl ethyl ketone; water; and mixtures thereof.

The reaction of asym-dichloroacetone with dimercaptan can also be carried out in the presence of a dehydrating reagent. The dehydrating reagent can be selected from a wide variety known in the art. Suitable dehydrating reagents for use in this reaction can include but are not limited to magnesium sulfate. The amount of dehydrating reagent can vary widely according to the stoichiometry of the dehydrating reaction.

The polythiols for use in material (b) in the preparation of the polyurethane material in the first component can be prepared in certain non-limiting embodiments by reacting 2-methyl-2-dichloromethyl-1,3-dithiolane with dimercaptodiethylsulfide to produce dimercapto-1,3-dithiolane derivative of formula III. Alternatively, 2-methyl-2-dichloromethyl-1,3-dithiolane can be reacted with 1,2-ethanedithiol to produce dimercapto-1,3-dithiolane derivative of formula II. 2-methyl-2-dichloromethyl-1,3-dithiane can be reacted with dimercaptodiethylsulfide to produce dimercapto-1,3-dithiane derivative of formula V. Also, 2-methyl-2-dichloromethyl-1,3-dithiane can be reacted with 1,2-ethanedithiol to produce dimercapto-1,3-dithiane derivative of formula IV.

Another non-limiting example of a dithiol suitable for use as the material (b) can include at least one dithiol oligomer prepared by reacting dichloro derivative with dimercaptoalkylsulfide as follows: 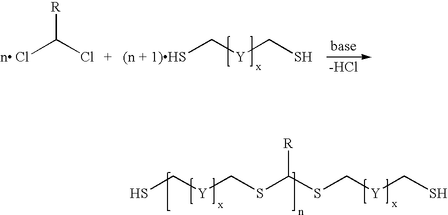
wherein R can represent CH₃, CH₃CO, C₁ to C₁₀ alkyl, cycloalkyl, aryl alkyl, or alkyl-CO; Y can represent C₁ to C₁₀ alkyl, cycloalkyl, C₆ to C₁₄ aryl, (CH₂)ₚ(S)ₘ(CH₂)_{q}, (CH₂)ₚ(Se)ₘ(CH₂)_{q}, (CH₂)ₚ(Te)ₘ(CH₂)_{q} wherein m can be an integer from 1 to 5 and, p and q can each be an integer from 1 to 10; n can be an integer from 1 to 20; and x can be an integer from 0 to 10.

The reaction of dichloro derivative with dimercaptoalkylsulfide can be carried out in the presence of a base. Suitable bases include any known to those skilled in the art in addition to those disclosed above.

The reaction of dichloro derivative with dimercaptoalkylsulfide may be carried out in the presence of a phase transfer catalyst. Suitable phase transfer catalysts for use in the present invention are known and varied. Non-limiting examples can include but are not limited to tetraalkylammonium salts and tetraalkylphosphonium salts. This reaction is often carried out in the presence of tetrabutylphosphonium bromide as phase transfer catalyst. The amount of phase transfer catalyst can vary widely, from 0 to 50 equivalent percent, or from 0 to 10 equivalent percent, or from 0 to 5 equivalent percent, relative to the dimercaptosulfide reactants.

The polythiols for use in material (b) may further contain hydroxyl functionality. Non-limiting examples of suitable materials having both hydroxyl and multiple (more than one) thiol groups can include but are not limited to glycerin bis(2-mercaptoacetate), glycerin bis(3-mercaptopropionate), 1,3-dimercapto-2-propanol, 2,3-dimercapto-1-propanol, trimethylolpropane bis(2-mercaptoacetate), tri methylol propane bis(3-mercaptopropionate), pentaerythritol bis(2-mercaptoacetate), pentaerythritol tris(2-mercaptoacetate), pentaerythritol bis(3-mercaptopropionate), pentaerythritol tris(3-mercaptopropionate), and mixtures thereof.

In addition to dithiols disclosed above, particular examples of suitable dithiols can include 1,2-ethanedithiol, 1,2-propanedithiol, 1,3-propanedithiol, 1,3-butanedithiol, 1,4-butanedithiol, 2,3-butanedithiol, 1,3-pentanedithiol, 1,5-pentanedithiol, 1,6-hexanedithiol, 1,3-dimercapto-3-methylbutane, dipentenedimercaptan, ethylcyclohexyldithiol (ECHDT), dimercaptodiethylsulfide (DMDS), methyl-substituted dimercaptodiethylsulfide, di methyl-substituted dimercaptodiethylsulfide, 3,6-dioxa-1,8-octanedithiol, 1,5-dimercapto-3-oxapentane, 2,5-dimercaptomethyl-1,4-dithiane (DMMD),ethylene glycol di(2-mercaptoacetate), ethylene glycol di(3-mercaptopropionate), and mixtures thereof.

Suitable trifunctional or higher-functional polythiols for use in material (b) can be selected from a wide variety known in the art. Non-limiting examples can include pentaerythritol tetrakis(2-mercaptoacetate), pentaerythritol tetrakis(3-mercaptopropionate), trimethylolpropane tris(2-mercaptoacetate), trimethylol propane tris(3-mercaptopropionate), and/or thioglycerol bis(2-mercaptoacetate).

For example, the polythiol can be chosen from materials represented by the following general formula, 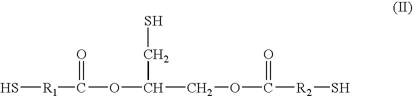
wherein R₁ and R₂ can each be independently chosen from straight or branched chain alkylene, cyclic alkylene, phenylene and C₁-C₉ alkyl substituted phenylene. Non-limiting examples of straight or branched chain alkylene can include methylene, ethylene, 1,3-propylene, 1,2-propylene, 1,4-butylene, 1,2-butylene, pentylene, hexylene, heptylene, octylene, nonylene, decylene, undecylene, octadecylene and icosylene. Non-limiting examples of cyclic alkylenes can include cyclopentylene, cyclohexylene, cycloheptylene, cyclooctylene, and alkyl-substituted derivatives thereof. The divalent linking groups R₁ and R₂ can be chosen from methylene, ethylene, phenylene, and alkyl-substituted phenylene, such as methyl, ethyl, propyl, isopropyl and nonyl substituted phenylene.

In particular embodiments, a polythiol may be prepared by reacting together (1) any of the dithiols mentioned above, and (2) a compound having at least two double bonds (for example, a diene).

The compound (2) having at least two double bonds can be chosen from non-cyclic dienes, including straight chain and/or branched aliphatic non-cyclic dienes, non-aromatic ring-containing dienes, including non-aromatic ring-containing dienes wherein the double bonds can be contained within the ring or not contained within the ring or any combination thereof, and wherein the non-aromatic ring-containing dienes can contain non-aromatic monocyclic groups or non-aromatic polycyclic groups or combinations thereof; aromatic ring-containing dienes; or heterocyclic ring-containing dienes; or dienes containing any combination of such non-cyclic and/or cyclic groups. The dienes can optionally contain thioether, disulfide, polysulfide, sulfone, ester, thioester, carbonate, thiocarbonate, urethane, or thiourethane linkages, or halogen substituents, or combinations thereof; with the proviso that the dienes contain double bonds capable of undergoing reaction with SH groups of a polythiol, and forming covalent C—S bonds. Often the compound (2) having at least two double bonds comprises a mixture of dienes that are different from one another.

The compound (2) having at least two double bonds may comprise acyclic non-conjugated dienes, acyclic polyvinyl ethers, allyl-(meth)acrylates vinyl-(meth)acrylates, di(meth)acrylate esters of diols, di(meth)acrylate esters of dithiols, di(meth)acrylate esters of poly(alkyleneglycol) diols, monocyclic non-aromatic dienes, polycyclic non-aromatic dienes, aromatic ring-containing dienes, diallyl esters of aromatic ring dicarboxylic acids, divinyl esters of aromatic ring dicarboxylic acids, and/or mixtures thereof.

Non-limiting examples of acyclic non-conjugated dienes can include those represented by the following general formula: 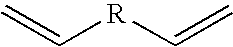
wherein R can represent C₁ to C₃₀ linear or branched divalent saturated alkylene radical, or C₂ to C₃₀ divalent organic radical including groups such as but not limited to those containing ether, thioether, ester, thioester, ketone, polysulfide, sulfone and combinations thereof. The acyclic non-conjugated dienes can be selected from 1,5-hexadiene, 1,6-heptadiene, 1,7-octadiene and mixtures thereof.

Non-limiting examples of suitable acyclic polyvinyl ethers can include those represented by the following structural formula:
CH₂═CH—O—(—R²—O—)ₘ—CH═CH₂
wherein R² can be C₂ to C₆ n-alkylene, C₃ to C₆ branched alkylene group, or—[(CH₂—)ₚ—O—]_{q}—(—CH₂—)ᵣ—, m can be a rational number from 0 to 10, often 2; p can be an integer from 2 to 6, q can be an integer from 1 to 5 and r can be an integer from 2 to 10.

Non-limiting examples of suitable polyvinyl ether monomers for use can include divinyl ether monomers, such as ethylene glycol divinyl ether, diethylene glycol divinyl ether, triethyleneglycol divinyl ether, and mixtures thereof.

Di(meth)acrylate esters of linear diols can include ethanediol di(meth)acrylate, 1,3-propanediol dimethacrylate, 1,2-propanediol di(meth)acrylate, 1,4-butanediol di(meth)acryl ate, 1,3-butanediol di(meth)acrylate, 1,2-butanediol di(meth)acrylate, and mixtures thereof.

Di(meth)acrylate esters of dithiols can include, for example, di(meth)acrylate of 1,2-ethanedithiol including oligomers thereof, di(meth)acrylate of dimercaptodiethyl sulfide (i.e., 2,2′-thioethanedithiol di(meth)acrylate) including oligomers thereof, di(meth)acrylate of 3,6-dioxa-1,8-octanedithiol including oligomers thereof, di(meth)acrylate of 2-mercaptoethyl ether including oligomers thereof, di(meth)acrylate of 4,4′-thiodibenzenethiol, and mixtures thereof.

Further non-limiting examples of suitable dienes can include monocyclic aliphatic dienes such as those represented by the following structural formula: 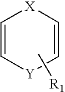
wherein X and Y each independently can represent C₁₋₁₀ divalent saturated alkylene radical; or C₁₋₅ divalent saturated alkylene radical, containing at least one element selected from the group of sulfur, oxygen and silicon in addition to the carbon and hydrogen atoms; and R₁ can represent H, or C₁-C₁₀ alkyl; and 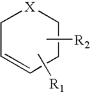
wherein X and R₁ can be as defined above and R₂ can represent C₂-C₁₀ alkenyl. The monocyclic aliphatic dienes can include 1,4-cyclohexadiene, 4-vinyl-1-cyclohexene, dipentene and terpinene.

Non-limiting examples of polycyclic aliphatic dienes can include 5-vinyl-2-norbornene; 2,5-norbornadiene; dicyclopentadiene and mixtures thereof.

Non-limiting examples of aromatic ring-containing dienes can include those represented by the following structural formula: 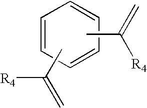
wherein R₄ can represent hydrogen or methyl. Aromatic ring-containing dienes can include monomers such as diisopropenyl benzene, divinyl benzene and mixtures thereof.

Examples of diallyl esters of aromatic ring dicarboxylic acids can include but are not limited to those represented by the following structural formula: 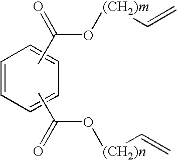
wherein m and n each independently can be an integer from 0 to 5. The diallyl esters of aromatic ring dicarboxylic acids can include o-diallyl phthalate, m-diallyl phthalate, p-diallyl phthalate and mixtures thereof.

The compound (2) having at least two double bonds can comprise 5-vinyl-2-norbornene, ethylene glycol divinyl ether, diethylene glycol divinyl ether, triethylene glycol divinyl ether, butane diol divinyl ether, vinylcyclohexene, 4-vinyl-1-cyclohexene, dipentene, terpinene, dicyclopentadiene, cyclododecadiene, cyclooctadiene, 2-cyclopenten-1 -yl-ether, 2,5-norbornadiene, divinylbenzene including 1,3-divinylbenzene, 1,2-divinylbenzene, and 1,4-divinylbenzene, diisopropenylbenzene including 1,3-diisopropenylbenzene, 1,2-diisopropenylbenzene, and 1,4-diisopropenylbenzene, allyl (meth)acrylate, ethanediol di(meth)acrylate, 1,3-propanediol di(meth)acrylate, 1,2-propanediol di(meth)acrylate, 1,3-butanediol di(meth)acrylate, 1,2-butanediol di(meth)acrylate, ethylene glycol di(meth)acrylate, diethylene glycol di(meth)acrylate, dimercaptodiethylsulfide di(meth)acrylate, 1,2-ethanedithiol di(meth)acrylate, and/or mixtures thereof.

Other non-limiting examples of suitable di(meth)acrylate monomers can include ethylene glycol di(meth)acrylate, 1,3-butylene glycol di(meth)acrylate, 1,4-butanediol di(meth)acrylate, 2,3-dimethyl-1,3-propanediol di(meth)acrylate, 1,6-hexanediol di(meth)acrylate, propylene glycol di(meth)acrylate, dipropylene glycol di(meth)acrylate, tripropylene glycol di(meth)acrylate, tetrapropylene glycol di(meth)acrylate, ethoxylated hexanediol di(meth)acrylate, propoxylated hexanediol di(meth)acrylate, neopentyl glycol di(meth)acrylate, alkoxylated neopentyl glycol di(meth)acrylate, hexylene glycol di(meth)acrylate, diethylene glycol di(meth)acrylate, polyethylene glycol di(meth)acrylate, thiodiethyleneglycol di(meth)acrylate, trimethylene glycol di(meth)acrylate, triethylene glycol di(meth)acrylate, alkoxylated hexanediol di(meth)acrylate, alkoxylated neopentyl glycol di(meth)acrylate, pentanediol di(meth)acrylate, cyclohexane dimethanol di(meth)acrylate, and ethoxylated bis-phenol A di(meth)acrylate.

The polythiols for use in material (b) in the preparation of the polyurethane material in the first component, when reacted with a polyisocyanate (a), can produce a polymerizate having a refractive index of at least 1.50, such as at least 1.52, or at least 1.55, or at least 1.60, or at least 1.65, or at least 1.67. Additionally, the polythiols for use in material (b) in the preparation of the polyurethane material in the first component, when reacted with a polyisocyanate (a), can produce a polymerizate having an Abbe number of at least 30, such as at least 35, or at least 38, or at least 39, or at least 40, or at least 44. The refractive index and Abbe number can be determined by methods known in the art such as American Standard Test Method (ASTM) Number D 542-00, using various known instruments. The refractive index and Abbe number can also be measured in accordance with ASTM D 542-00 with the following exceptions: (i) test one to two samples/specimens instead of the minimum of three specimens specified in Section 7.3; and (ii) test the samples unconditioned instead of conditioning the samples/specimens prior to testing as specified in Section 8.1. Further, an Atago model DR-M2 Multi-Wavelength Digital Abbe Refractometer can be used to measure the refractive index and Abbe number of the samples/specimens.

Suitable polythiols also can include the thioether-functional oligomeric polythiols described in U.S. patent application Ser. No. 11/744,247 at [0025]-[0092]and [0093]-0094] incorporated by reference herein.

The polythiols for use in material (b) in the preparation of the polyurethane material in the first component, when reacted with a polyisocyanate (a), can produce a polymerizate having a Martens hardness of at least 20 N/mm², or often at least 50, or more often between 70 and 200. Such polymerizates are typically not elastomeric; i.e., they are not substantially reversibly deformable (e. g., stretchable) due to their rigidity and do not typically exhibit properties characteristic of rubber and other elastomeric polymers.

Polyamines (including diamines) are also suitable for use in the material (b) used to prepare the polyurethane material of the first component.

Suitable materials having amine functional groups for use in the material (b) used to prepare the polyurethane material of the first component may have at least two primary and/or secondary amine groups (polyamine). Non-limiting examples of suitable polyamines include primary or secondary diamines or polyamines in which the radicals attached to the nitrogen atoms can be saturated or unsaturated, aliphatic, alicyclic, aromatic, aromatic-substituted-aliphatic, aliphatic-substituted-aromatic, and heterocyclic. Non-limiting examples of suitable aliphatic and alicyclic diamines include 1,2-ethylene diamine, 1,2-propylene diamine, 1,8-octane diamine, isophorone diamine, propane-2,2-cyclohexyl amine, and the like. Non-limiting examples of suitable aromatic diamines include phenylene diamines and toluene diamines, for example o-phenylene diamine and p-tolylene diamine. Polynuclear aromatic diamines such as 4,4′-biphenyl diamine, 4,4′-methylene dianiline and monochloro- and dichloro-derivatives of 4,4′-methylene dianiline are also suitable.

Polyamines suitable for use in the present invention can include but are not limited to materials having the following chemical formula: 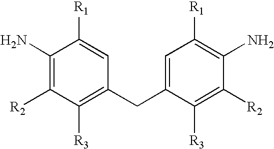
wherein R₁ and R₂ can each be independently chosen from methyl, ethyl, propyl, and isopropyl groups, and R₃ can be chosen from hydrogen and chlorine. Non-limiting examples of polyamines for use in the present invention include the following compounds, manufactured by Lonza Ltd. (Basel, Switzerland):

LONZACURE® M-DIPA: R₁═C₃ H₇; R₂═C₃ H₇; R₃═H

LONZACURE® M-DMA: R₁═CH₃; R₂═CH₃; R₃═H

LONZACURE® M-MEA: R₁═CH₃; R₂═C₂ H₅; R₃═H

LONZACURE® M-DEA: R₁═C₂ H₅; R₂═C₂ H₅; R₃═H

LONZACURE® M-MIPA: R₁═CH₃; R₂═C₃ H₇; R₃═H

LONZACURE® M-CDEA: R₁═C₂ H₅; R₂═C₂ H₅; R₃═Cl

wherein R₁, R₂ and R₃ correspond to the aforementioned chemical formula.

The polyamine can include a diamine reactive compound such as 4,4′-methylenebis(3-chloro-2,6-diethylaniline), (Lonzacure® M-CDEA), which is available in the United States from Air Products and Chemical, Inc. (Allentown, Pa.); 2,4-diamino-3,5-diethyl-toluene, 2,6-diamino-3,5-diethyl-toluene and mixtures thereof (collectively “diethyltoluenediamine” or “DETDA”), which is commercially available from Albemarle Corporation under the trade name Ethacure 100; dimethylthiotoluenediamine (DMTDA), which is commercially available from Albemarle Corporation under the trade name Ethacure 300; 4,4′-methylene-bis-(2-chloroaniline) which is commercially available from Kingyorker Chemicals as MOCA. DETDA can be a liquid at room temperature with a viscosity of 156 cPs at 25° C. DETDA can be isomeric, with the 2,4-isomer range being from 75 to 81 percent while the 2,6-isomer range can be from 18 to 24 percent. The color stabilized version of Ethacure 100 (i.e., formulation which contains an additive to reduce yellow color), which is available under the name Ethacure 100S may be used in the present invention.

Other examples of the polyamine can include ethyleneamines. Suitable ethyleneamines can include but are not limited to ethylenediamine (EDA), diethylenetriamine (DETA), triethylenetetramine (TETA), tetraethylenepentamine (TEPA), pentaethylenehexamine (PEHA), piperazine, morpholine, substituted morpholine, piperidine, substituted piperidine, diethylenediamine (DEDA), and 2-amino-1-ethylpiperazine. In particular embodiments, the polyamine can be chosen from one or more isomers of C₁-C₃ dialkyl toluenediamine, such as but not limited to 3,5-dimethyl-2,4-toluenediamine, 3,5-dimethyl-2,6-toluenediamine, 3,5-diethyl-2,4-toluenediamine, 3,5-diethyl-2,6-toluenediamine, 3,5-diisopropyl-2,4-toluenediamine, 3,5-diisopropyl-2,6-toluenediamine, and mixtures thereof. Methylene dianiline and trimethyleneglycol di(para-aminobenzoate) are also suitable.

Additional examples of suitable polyamines include methylene bis anilines, aniline sulfides, and bianilines, any of which may be hetero-substituted, provided the substituents do not interfere with any reactions to take place among the reactants. Specific examples include 4,4′-methylene-bis(2,6-dimethylaniline), 4,4′-methylene-bis(2,6-diethylaniline), 4,4′-methylene-bis(2-ethyl-6-methylaniline), 4,4′-methylene-bis(2,6-diisopropylaniline), 4,4′-methylene-bis(2-isopropyl-6-methylaniline) and 4,4′-methylene-bis(2,6-diethyl-3-chloroaniline).

Frequently used suitable materials having amine functional groups include isomers of diethylene toluenediamine, methylene dianiline, methyl diisopropyl aniline, methyl diethyl aniline, trimethylene glycol di-para aminobenzoate, 4,4′-methylene-bis(2,6-diisopropylaniline), 4,4′-methylene-bis(2,6-dimethylaniline), 4,4′-methylene-bis(2-ethyl-6-methylaniline), 4,4′-methylene-bis(2,6-diethylaniline), 4,4′-methylene-bis(2-isopropyl-6-methylaniline), and/or 4,4′-methylene-bis(2,6-diethyl-3-chloroaniline). Suitable diamines are also described in detail in U.S. Pat. No. 5,811,506, column 3, line 44, to column 5, line 25, incorporated herein by reference.

In certain embodiments of the present invention the isocyanate functional groups on the material in the first component may be at least partially capped. If isocyanate groups are to be blocked or capped, any suitable aliphatic, cycloaliphatic, or aromatic alkyl monoalcohol or phenolic compound known to those skilled in the art can be used as a capping agent. Examples of suitable blocking agents include those materials which would unblock at elevated temperatures such as lower aliphatic alcohols including methanol, ethanol, and n-butanol; cycloaliphatic alcohols such as cyclohexanol; aromatic-alkyl alcohols such as phenyl carbinol and methylphenyl carbinol; and phenolic compounds such as phenol itself and substituted phenols wherein the substituents do not affect coating operations, such as cresol and nitrophenol. Glycol ethers may also be used as capping agents. Suitable glycol ethers include ethylene glycol butyl ether, diethylene glycol butyl ether, ethylene glycol methyl ether and propylene glycol methyl ether. Other suitable capping agents include oximes such as methyl ethyl ketoxime, acetone oxime and cyclohexanone oxime, lactams such as epsilon-caprolactam, pyrazoles such as dimethyl pyrazole, and amines such as diisopropylamine.

In certain embodiments of the present invention the material having isocyanate functional groups in the first component may have a number average molecular weight of up to 1000, or up to 500, or up to 300, as determined by gel permeation chromatography using a polystyrene standard.

In separate non-limiting embodiments of the present invention the material having isocyanate functional groups may have a number average molecular weight of greater than 1000, or at least 1500, or at least 2500, as determined by gel permeation chromatography using a polystyrene standard.

The first component may further comprise a solvent. Suitable solvents may include any organic solvents known to those skilled in the art, provided they are not reactive with isocyanate functional groups. Potential solvents can include, but are not limited to, the following: acetone, amyl propionate, anisole, benzene, butyl acetate, cyclohexane, dialkyl ethers of ethylene glycol, e.g., diethylene glycol dimethyl ether and their derivates (sold as CELLOSOLVE® industrial solvents), diethylene glycol dibenzoate, dimethyl sulfoxide, dimethyl formamide, dimethoxybenzene, ethyl acetate, methyl cyclohexanone, cyclopentanone, methyl ethyl ketone, methyl isobutyl ketone, methyl propionate, propylene carbonate, tetrahydrofuran, toluene, xylene, 2-methoxyethyl ether, 3-propylene glycol methyl ether, and mixtures thereof. In addition to or in lieu of the aforementioned organic solvents, halogenated solvents, e.g. halogenated alkanes such as methylene chloride can be employed. The solvent may be present in the first component in an amount of 0 to 95 percent by weight, or 20 to 80 percent by weight, or 40 to 60 percent by weight, based on the total weight of the first component.

The second component used in the process of the present invention comprises a material having active hydrogen functional groups that are reactive with isocyanate.

Suitable materials having active hydrogen functional groups may include any of those disclosed above as material (b) in the preparation of the polyurethane material having isocyanate functional groups in the first component.

The second component may further comprise a solvent. Suitable solvents may include any of those disclosed above. The solvent may be present in the second component in an amount of 0 to 95 percent by weight, or 20 to 80 percent by weight, or 40 to 60 percent by weight, based on the total weight of the second component.

In step (c) of the method of the present invention, the first and second components are combined to form a reaction mixture. The reaction mixture may further comprise a solvent, in addition to or in place of solvents in either or both of the individual components. The solvent may be any of those disclosed above. The solvent may be present in the reaction mixture in an amount of 0 to 95 percent by weight, or 20 to 80 percent by weight, or 40 to 60 percent by weight, based on the total weight of the reaction mixture.

In certain embodiments of the present invention, the reaction mixture may further comprise a surfactant such as any of those well known in the art. Suitable surfactants can include, but are not limited to, those sold under the name MEDAFLOW®, available from Solutia, Inc.; BYK-307® and BYK-377®, available from BYK-Chemie, and/or MULTIFLOW®, available from Cytec Surface Specialties. The surfactant may be present in the reaction mixture in an amount of up to 0.2 percent by weight, such as up to 0.1 percent by weight, or up to 0.07 percent by weight, based on the total weight of resin solids in the reaction mixture.

In certain embodiments of the present invention, the reaction mixture may further comprise a catalyst to aid in the reaction of isocyanate functional groups with amine functional groups. Suitable catalysts can be selected from those known in the art. Non-limiting examples can include tertiary amine catalysts such as but not limited to triethylamine, triisopropylamine, dimethyl cyclohexylamine, N,N-dimethylbenzylamine and mixtures thereof. Such suitable tertiary amines are disclosed in U.S. Pat. No. 5,693,738 at column 10, lines 6-38, the disclosure of which is incorporated herein by reference. Other suitable catalysts include phosphines, tertiary ammonium salts, organophosphorus compounds, tin compounds such as dibutyl tin dilaurate, or mixtures thereof, depending on the nature of the various reactive components.

After the first and second components are combined to form the reaction mixture, the reaction mixture may be cast onto a support substrate as in a conventional solvent casting process. Such substrates generally have smooth surfaces and may comprise, for example, glass, stainless steel, and the like, provided the material from which the substrate is made can withstand the subsequent curing temperatures.

The reaction mixture is cast onto the support substrate in a substantially uniform thickness to yield a dry film thickness of 0.5 to 20 mils (12.7 to 508 microns), such as 1 to 10 mils (25.4 to 254 microns), or 2 to 4 mils (50.8 to 101.6 microns) after cure.

After application of the reaction mixture to the substrate, a film is formed on the surface of the substrate by driving solvents out of the film by mild heating or by an air-drying period, typically involving exposure to ambient conditions for about 1 to 20 minutes. The film on the substrate is then heated to a temperature and for a time sufficient to yield a cured film. In the curing operation, solvents are driven off and the reactive functional groups in the reaction mixture continue to be or are reacted together. In the making of a polyurethane-urea film, for example, the heating or curing operation may be carried out at a temperature in the range of from 100-210° C. for 10 to 100 minutes. In alternate embodiments, curing may be carried out at a lower temperature range of ambient (e.g., 23-27° C.) to 100° C. for a longer time period such as from 100 minutes to five days. Cure temperatures and dwell times will be dependent on the nature of the reactants, including type of reactive groups, the presence and type of any catalysts, etc. After an effective curing operation, the cured film may be removed from the support substrate to yield a free film. A mold release agent can be included as an ingredient in the composition used to prepare the polyurethane-containing free film. Classes of mold release agents that may be incorporated into the composition used to prepare the polyurethane-containing free film can include, but are not limited to hydrocarbon-based mold release agents, fatty acid-based release agents, fatty acid amide-based mold release agents, alcohol-based mold release agents, fatty acid ester-based mold release agents, silicone-based mold release agents, C₈ to C₁₆ alkyl phosphate ester based mold release agents and mixtures or combinations thereof. Suitable examples of hydrocarbon-based mold release agents include, synthetic paraffins, polyethylene waxes and fluorocarbons. Fatty acid-based release agents that may be used include, for example, stearic acid and hydroxystearic acid. Fatty acid amide-based mold release agents that may be used can include, for example, stearic acid amide, ethylenebisstearoamide and alkylenebisfatty acid amides. Examples of alcohol-based mold release agents can include, stearyl alcohol, cetyl alcohol, and polyhydric alcohols such as polyglycols and polyglycerols. An example of a fatty acid ester-based mold release agent that may be included is butyl stearate. An example of a C₈ to C₁₆ alkyl phosphate ester based mold release agent is ZELEC® UN manufactured by Stepan Company.

The resulting cured, non-elastomeric polyurethane-containing free film is non-birefringent. The free film is non-birefringent both in-plane and out-of-plane. The free film can be non-birefringent in three dimensions. Birefringence is determined as described hereinbelow in the Examples. In certain embodiments, the film may be capable of demonstrating a stress at break of at least 9000 psi, and a strain at break of at least 70 percent, as determined using an Instron model 5543 tensile tester.

The cured, non-elastomeric polyurethane-containing free film prepared according to the method above may be used to form a polarizing optical element in accordance with the present invention.

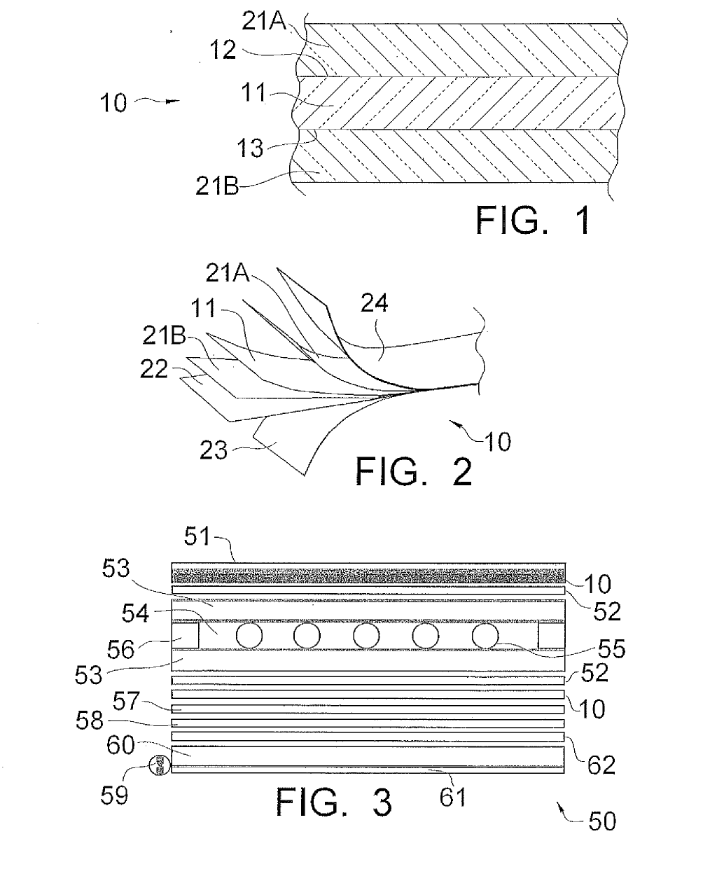

As previously mentioned, the present invention also is directed to a polarizing optical element comprising (a) a polarizing film layer having two opposing surfaces; and (b) a protective, supportive layer comprising any of the cured, non-elastomeric polyurethane-containing free films described above appended to at least one of the opposed surfaces of the polarizing film layer. One embodiment of the optical element is illustrated in FIG. 1. The polarizing optical element 10 of the present invention as shown in FIG. 1 comprises, in combination:

a) a polarizing film layer 11 having two opposed surfaces 12 and 13; and

b) a protective, supportive layer 21A and 21B at least one of which comprises a cured, non-elastomeric polyurethane-containing free film appended to each of the opposed surfaces 12 and 13 of the polarizing layer, such that the polarizing film layer 11 is positioned between each of two supportive layers 21A and 21B.

As mentioned above, at least one of the protective, supportive layers comprises a cured, non-elastomeric polyurethane-containing free film. In a particular embodiment, both of the protective, supportive layers comprises a cured, non-elastomeric polyurethane-containing film.

In embodiments wherein one of the layers comprises a cured, non-elastomeric polyurethane-containing film, the other protective, supportive layer can comprise a different material chosen from any of a wide variety of materials well known in the art. For example, the protective, supportive layer (i.e., a coating, a film, or a free film) can comprise polycarbonate, polycyclic alkene, polyurethane, poly(urea)urethane, polythiourethane, polythio(urea)urethane, polyol(allyl carbonate), cellulose acetate, cellulose diacetate, cellulose triacetate, cellulose acetate propionate, cellulose acetate butyrate, poly(vinyl acetate), poly(vinyl alcohol), poly(vinyl chloride), poly(vinylidene chloride), poly(ethylene terephthalate), polyester, polysulfone, polyolefin, copolymers thereof, and/or mixtures thereof. In a particular embodiment of the present invention, the protective, supportive layer which is different from the protective, supportive layer comprising a cured, non-elastomeric polyurethane-containing film can comprise cellulose acetate, cellulose diacetate, cellulose triacetate, cellulose acetate propionate, and/or cellulose acetate butyrate. The polarizing film layer may be formed from any known polarizing filter such as sheets or layers of a polymeric material that has been stretched or otherwise oriented and impregnated with, for example, an iodine chromophore or dichroic dye. For example, one method of forming a conventional polarizing filter for ophthalmic devices is to heat a sheet or layer of polyvinyl alcohol (“PVA”) to soften the PVA and then stretch the sheet to orient the PVA polymer chains. Thereafter, an iodine chromophore or dichroic dye is impregnated into the sheet such that the iodine or dye molecules attach to the aligned polymer chains and take on a particular order or alignment. Alternatively, the iodine chromophore or the dichroic dye can be first impregnated into the PVA sheet, and thereafter the sheet can be heated and stretched as described above to orient the PVA polymer chains and associated chromophore or dye. Polyethylene terephthalate (PET) polarizing films are also suitable.

Iodine chromophores and dichroic dyes are dichroic materials, that is, they absorb one of two orthogonal plane-polarized components of transmitted radiation more strongly than the other. Although dichroic materials will preferentially absorb one of two orthogonal plane-polarized components of transmitted radiation, if the molecules of the dichroic material are not suitably positioned or arranged, no net polarization of transmitted radiation will be achieved. That is, due to the random positioning of the molecules of the dichroic material, the selective absorption by the individual molecules will cancel each other such that no net or overall polarizing effect is achieved. However, by suitably positioning or arranging the molecules of the dichroic material within the oriented polymer chains of the PVA sheet, a net polarization can be achieved. That is, the PVA sheet can be made to polarize transmitted radiation, or in other words, a polarizing filter can be formed.

Methods of forming polarizing sheets or layers using liquid crystal materials are also known and such sheets may be used as the polarizing film layer in the optical element of the present invention. For example, polarizing sheets formed from oriented thermotropic liquid crystal films containing dichroic dyes are suitable. Alternatively, polarizing sheets formed by extruding liquid crystalline polymers that contain dichroic dyes covalently linked as part of the main polymer chains may be used.

In the optical element of the present invention, the thickness of the polarizing film layer may range from 0.1 to 10 mils (2.54 to 254 microns), or from 0.3 to 2 mils (7.62 to 50.8 microns), or from 0.4 to 0.7 mils (10.16 to 17.78 microns).

Referring again to FIG. 1, a cured, non-elastomeric polyurethane-containing free film is appended to at least one of the opposed surfaces 12 and 13 of the polarizing layer 11. The polarizing film layer 11 is thus effectively “sandwiched” in a position between each of two supportive layers 21A and 21B.

In such a multi-layered structure the polarizing film layer 11 and the supportive layers 21A and 21B may be adhered to each other, for example, with a pressure-sensitive adhesive. Alternatively, the layers may be adhered to each other by surface treatment of the polarizing film layer and/or the supportive layers prior to assembly of the optical element. Such surface treatment may include chemical or mechanical treatment such as etching or roughening by abrasion, physical or chemical cleaning, plasma treatment, corona treatment and/or application of coatings to promote adhesion. Art recognized lamination means can be employed as well. Moreover, any of the aforemention layers/films can comprise one or more adhesion promoters to facilitate adhesion of a layer to one or more other layers.

The polarizing optical element of the present invention may have additional light influencing properties such as a colored tint or photochromism. For example, the protective, supportive layer(s) can comprise colorants to impart a tint. Likewise the protective, supportive layer(s) can comprise one or more photochromic materials such as any of those described below. For example, the photochromic material can be applied to the cured free film as a coating thereon; incorporated into the cured free film via imbibition processes; included as a component in the composition used to form the film prior to film formation. Also, the polarizing film layer can comprise a colorant and/or photochromic material in addition to the dichroic material. The polarizing film layer also may comprise a dichroic photochromic compound/material which imparts photochromicity as well as polarization to the film.

The polarizing optical element 10 of the present invention may further comprise additional layers superposed on one or both of the supportive layers 21A and 21B, as illustrated, for example, in FIG. 2. Non-limiting examples can include removable protective films 24 to protect the element from scratching and other damage during transport, pressure-sensitive adhesives 22 with removable release films 23 to aid application of the element to multi-layer optical articles, and the like. Photochromic coatings or films such as those disclosed below, may also be included.

As noted above, the polarizing optical element of the present invention may be used as a component in a multi-layer optical article. For example, in accordance with the present invention, a polarizing optical article is provided, comprising, in combination:

a) a substrate; and

b) a polarizing optical element such as any of those described above.

Optical articles of the present invention may include ophthalmic articles such as piano (without optical power) and vision correcting (prescription) lenses (finished and semi-finished) including multifocal lenses (bifocal, trifocal, and progressive lenses); and ocular devices such as contact lenses and intraocular lenses, sun lenses, fashion lenses, sport masks, face shields and goggles. The optical article may also be chosen from displays, screens (such as touch screens), glazings such as windows and vehicular transparencies such as automobile or aircraft windshields and side windows. In a particular embodiment of the present invention, the optical article is a component of a liquid crystal display.

The optical articles of the present invention may be adapted to possess a light influencing property such as a color or tint and/or photochromism. Such properties may be of more than one type and may be imparted to any of the components of the optical article, including the substrate, the polarizing optical elements, and/or any superposed coatings or films which have been applied to the substrate and/or to any of the layers comprising the polarizing optical element.

The substrate a) used in the polarizing optical element of present invention comprises an optical substrate and may be chosen from, inter alia, mineral glass, ceramic, e.g., solgel, and polymeric organic materials. The substrate may be rigid, i.e., capable of maintaining its shape and supporting the applied curable film-forming composition. The optical substrate, including any coatings or treatments applied thereto, may be adapted to possess at least one light influencing property as discussed above. In one embodiment of the present invention the substrate is a polymeric organic material such as an optically clear polymerizate, e.g., material suitable for optical applications, such as ophthalmic articles. Such optically clear polymerizates have a refractive index that may vary widely. Examples include polymerizates of optical resins such as thermoplastic polycarbonate and optical resins sold by PPG Industries, Inc. as TRIVEX® monomer composition and under the CR-designation, e.g., CR-39® monomer composition. High refractive index polythiourethane substrates available from Mitsui Chemicals Co., Ltd., under the names MR-6, MR-7, MR-8, and MR-10 are also suitable. Non-limiting examples of other suitable substrates are disclosed in U.S. Patent Publication 2004/0096666 in paragraphs [0061] and [0064] to [0081], incorporated herein by reference.

The substrate used in the optical article of the present invention may comprise polymeric organic material chosen from thermoplastic material, thermosetting material and mixtures thereof. Suitable examples of such materials are described in the Kirk-Othmer Encyclopedia of Chemical Technology, Fourth Edition, Volume 6, pages 669 to 760. Thermoplastic materials can be made substantially thermoplastic or thermosetting by the appropriate chemical modification, as known to those skilled in the art.

Further examples of optical resins that may be used as substrates in the present invention include the resins used to form hard and soft contact lenses such as are disclosed in U.S. Pat. No. 5,166,345, column 11, line 52, to column 12, line 52, soft contact lenses with high moisture content as described in U.S. Pat. No. 5,965,630 and extended wear contact lenses as described in U.S. Pat. No. 5,965,631, which disclosures related to optical resins for contact lenses are incorporated herein by reference.

The substrate can itself comprise a display, screen, lens, windshield, ophthalmic article, or glazing.

In certain embodiments, the substrate may include a coating or film on the surface thereof, wherein the coating or film imparts a light influencing property and/or provides protection to the substrate from abrasion or other damage. Examples of suitable abrasion resistant coatings include those disclosed in published U.S. Patent Application No. 2004/0207809, paragraphs [0205]-[0249], incorporated herein by reference. Suitable coatings designed to provide impact resistance include those disclosed in U.S. Pat. No. 5,316,791, col. 3, line 7-col. 7, line 35, incorporated herein by reference. Other suitable coatings and films are discussed in more detail below.

The polarizing optical element is appended to at least one surface of the substrate. Optionally there may be one or more intervening layers between the substrate and the polarizing optical element as noted above. One suitable intervening layer may comprise a retardation compensation layer, as is often used as a component in liquid crystal displays for compensating a change in the retardation caused when light passes through the display cell so as to improve viewing angle characteristics. There additionally may be coatings or films such as those described above superposed on the polarizing optical element.

FIG. 3 illustrates a particular embodiment of the present invention, a cross section of a liquid crystal display 50. A liquid crystal layer comprising liquid crystal 54, cell spacers 55 and sealing material 56 is layered between two glass substrates 53. Superposed on the glass substrates 53 are retardation compensation films 52 and polarizing optical elements 10. A lens sheet 51 is superimposed on a top polarizing optical element 10 to form the outermost surface of the liquid crystal display. Inner layers of the liquid crystal display 50 include a polarized separation film 57, a condensing sheet 58, a diffuser 62, a light guided plate 60, and a reflector 61. Light source 59 can be, for example, a cold cathode fluorescent lamp.

A wide variety of photochromic materials may be used in the optical article of the present invention to provide a light influencing property. Such materials may be imbibed into the substrate or incorporated into a coating as known in the art then applied to the substrate. Moreover, photochromic materials may comprise the substrate and the optical element appended to the substrate and/or the photochromic material may comprise both the substrate and the optical element. The photochromic materials may be provided in a variety of forms. Examples include: a single photochromic compound; a mixture of photochromic compounds; a material containing a photochromic compound, such as a monomeric or polymeric ungelled solution; a material such as a monomer or polymer to which a photochromic compound is chemically bonded; a material comprising and/or having chemically bonded to it a photochromic compound, the outer surface of the material being encapsulated (encapsulation is a form of coating), for example with a polymeric resin or a protective coating such as a metal oxide that prevents contact of the photochromic material with external materials such as oxygen, moisture and/or chemicals that have a negative effect on the photochromic material; such materials can be formed into a particulate prior to applying a protective coating as described in U.S. Pat. Nos. 4,166,043 and 4,367,170; a photochromic polymer, e.g., a photochromic polymer comprising photochromic compounds bonded together; or mixtures thereof.

The inorganic photochromic material may contain crystallites of silver halide, cadmium halide and/or copper halide. Other inorganic photochromic materials may be prepared by the addition of europium (II) and/or cerium(lIl) to a mineral glass such as a soda-silica glass. In another non-limiting embodiment, the inorganic photochromic materials are added to molten glass and formed into particles that are incorporated into a film-forming composition that may be applied to the substrate. Such inorganic photochromic materials are described in Kirk Othmer Encyclopedia of Chemical Technology, 4th Edition, Volume 6, pages 322-325.

The photochromic material may be an organic photochromic material having an activated absorption maxima in the range from 300 to 1000 nanometers. In one embodiment, the organic photochromic material comprises a mixture of (a) an organic photochromic material having a visible lambda max of from 400 to less than 550 nanometers, and (b) an organic photochromic material having a visible lambda max of from 550 to 700 nanometers.

The photochromic material may alternatively comprise an organic photochromic material that may be chosen from pyrans, oxazines, fulgides, fulgimides, diarylethenes and mixtures thereof.

Non-limiting examples of photochromic pyrans that may be used herein include benzopyrans, and naphthopyrans, e.g., naphtho[1,2-b]pyrans, naphtho[2,1 -b]pyrans, indeno-fused naphthopyrans and heterocyclic-fused naphthopyrans, spiro-9-fluoreno[1,2-b]pyrans, phenanthropyrans, quinolinopyrans; fluoroanthenopyrans and spiropyrans, e.g., spiro(benzindoline)naphthopyrans, spiro(indoline)benzopyrans, spiro(indoline)naphthopyrans, spiro(indoline)quinolinopyrans and spiro(indoline)pyrans and mixtures thereof. Non-limiting examples of benzopyrans and naphthopyrans are disclosed in U.S. Pat. No. 5,645,767 at column 2, line 16 to column 12, line 57; U.S. Pat. No. 5,723,072 at column 2, line 27 to column 15, line 55; U.S. Pat. No. 5,698,141 at column 2, line 11 to column 19, line 45; U.S. Pat. No. 6,022,497 at column 2, line 21 to column 11, line 46; U.S. Pat. No. 6,080,338 at column 2, line 21 to column 14, line 43; U.S. Pat. No. 6,136,968 at column 2, line 43 to column 20, line 67; U.S. Pat. No. 6,153,126 at column 2, line 26 to column 8, line 60; U.S. Pat. No. 6,296,785 at column 2, line 47 to column 31, line 5; U.S. Pat. No. 6,348,604 at column 3, line 26 to column 17, line 15; U.S. Pat. No. 6,353,102 at column 1, line 62 to column 11, line 64; U.S. Pat. No. 6,630,597 at column 2, line 16 to column 16, line 23; and U.S. Pat. No. 6,736,998 at column 2, line 53 to column 19, line 7 which disclosures are incorporated herein by reference. Further non-limiting examples of naphthopyrans and complementary organic photochromic substances are described in U.S. Pat. No. 5,658,501 at column 1, line 64 to column 13, line 17, which disclosure is incorporated herein by reference. Spiro(indoline)pyrans are also described in the text, Techniques in Chemistry, Volume II, “Photochromism”, Chapter 3, Glenn H. Brown, Editor, John Wiley and Sons, Inc., New York, 1971.

Examples of photochromic oxazines that may be used include benzoxazines, naphthoxazines, and spiro-oxazines, e.g., spiro(indoline)naphthoxazines, spiro(indoline)pyridobenzoxazines, spiro(benzindoline)pyridobenzoxazines, spiro(benzindoline)naphthoxazines, spiro(indoline)benzoxazines, spiro(indoline)fluoranthenoxazine, spiro(indoline)quinoxazine and mixtures thereof.

Examples of photochromic fulgides or fulgimides that may be used include: fulgides and fulgimides, which are disclosed in U.S. Pat. No. 4,685,783 at column 1, line 57 to column 5, line 27, and in U.S. Pat. No. 4,931,220 at column 1, line 39 through column 22, line 41, the disclosure of such fulgides and fulgimides are incorporated herein by reference. Non-limiting examples of diarylethenes are disclosed in U.S. Patent Application 2003/0174560 paragraphs [0025] to [0086].

Polymerizable organic photochromic materials, such as polymerizable naphthoxazines disclosed in U.S. Pat. No. 5,166,345 at column 3, line 36 to column 14, line 3; polymerizable spirobenzopyrans disclosed in U.S. Pat. No. 5,236,958 at column 1, line 45 to column 6, line 65; polymerizable spirobenzopyrans and spirobenzothiopyrans disclosed in U.S. Pat. No. 5,252,742 at column 1, line 45 to column 6, line 65; polymerizable fulgides disclosed in U.S. Pat. No. 5,359,085 at column 5, line 25 to column 19, line 55; polymerizable naphthacenediones disclosed in U.S. Pat. No. 5,488,119 at column 1, line 29 to column 7, line 65; polymerizable spirooxazines disclosed in U.S. Pat. No. 5,821,287 at column 3, line 5 to column 11, line 39; polymerizable polyalkoxylated naphthopyrans disclosed in U.S. Pat. No. 6,113,814 at column 2, line 23 to column 23, line 29; and the polymeric matrix compatibilized naphthopyran of U.S. Pat. No. 6,555,028 at column 2, line 40 to column 24, line 56 may be used. The disclosures of the aforementioned patents on polymerizable organic photochromic materials are incorporated herein by reference.

Typically the photochromic material is present in the optical article in a photochromic amount; that is, in an amount yielding a color change distinguishable by the naked eye upon exposure to radiation.

In a particular embodiment of the present invention, the polarizing optical article comprises a component of a liquid crystal display. In a typical liquid crystal display, a liquid crystal is sealed between two glass substrates. Retardation films are superposed on the glass substrates, followed by application of polarizer films and any additional essential layers such as lenses, diffusers, protective layers, and the like. The polarizer films of the liquid crystal display may comprise the polarizing optical article of the present invention.

Conventional polarizer films in liquid crystal displays utilize cellulose triacetate (TAC) films as a support for the polarizing filter. The polarizing optical article of the present invention, which uses a curable, non-elastomeric polyurethane-containing free film, offers comparable optical transmittance and low birefringence, higher refractive index, temperature, chemical and solvent resistance, and elongation strength, and lower water permeation, without the need for a plasticizer. Moreover, the non-elastomer polyurethane-containing free film is compatible with and readily receives a wide variety of the films and coatings.

Other coatings or films suitable for use in the optical article of the present invention may comprise, inter alia, a tint coating and/or an abrasion resistant or other protective coating. Any of the coatings discussed earlier as applied directly to the substrate may additionally or alternatively be used as a superposed coating. Likewise, any coatings discussed here below as a superposed coating may additionally or alternatively be applied directly to the substrate.

The types of material used for such film or coating may vary widely and be chosen from the polymeric organic materials of the substrate and the protective films described hereinafter. The thickness of the films of polymeric organic materials may vary widely. The thickness may range, for example, from 0.1 mil to 40 mils and any range of thicknesses between these values, inclusive of the recited values. However, if desired, greater thicknesses may be used.

The polymeric organic materials may be chosen from thermosetting materials, thermoplastic materials and mixtures thereof. Such materials include the polymeric organic materials chosen for the substrate as well as protective films. Other examples of films of polymeric organic materials are disclosed in U.S. Patent Publication 2004/0096666 in paragraphs [0082] to [0098] which disclosure of such polymeric films is incorporated herein by reference.

In certain embodiments, the film or coating comprises thermoplastic polymeric organic materials chosen from nylon, poly(vinyl acetate), vinyl chloride-vinyl acetate copolymer, poly (C₁-C₈ alkyl) acrylates, poly (C₁-C8 alkyl) methacrylates, styrene-butadiene copolymer resin, poly(urea-urethanes), polyurethanes, polyterephthalates, polycarbonates, polycarbonate-silicone copolymer and mixtures thereof.

Optionally, compatible (chemically and color-wise) fixed tint dyes may be added or applied to the substrate and/or superposed films to achieve a more aesthetic result. For example, the dye may be selected to complement the color resulting from activated photochromic materials, e.g., to achieve a more neutral color or absorb a particular wavelength of incident light, as in a photochromic ophthalmic lens. In another embodiment, the dye may be selected to provide a desired hue to the host material or substrate.

In a further embodiment, the aforementioned fixed tint dyes may be associated with the protective films described hereinafter used with the optical articles of the present invention as known to those skilled in the art. See for example, U.S. Pat. No. 6,042,737 at column 4, line 43 to column 5, line 8, which disclosure related to tinting coated substrates is incorporated herein by reference.

A protective film can be applied to the substrate to prevent scratches from the effects of friction and abrasion. The protective film may also serve as a superposed film or coating. The protective film connected to the optical article of the present invention, in a particular embodiment, is an at least partially abrasion resistant film. The phrase “an at least partially abrasion resistant film” refers to an at least partial film of an at least partially cured coating or sheet of a protective polymeric material that demonstrates a resistance to abrasion that is greater than the standard reference material, typically a plastic made of CR-39® monomer available from PPG Industries, Inc, as tested in a method comparable to ASTM F-735 Standard Test Method for Abrasion Resistance of Transparent Plastics and Coatings Using the Oscillating Sand Method.

The protective film may be chosen from protective sheet materials, protective gradient films (which also provide a gradient in hardness for the films between which they are interposed), protective coatings and combinations thereof. Protective coatings such as hardcoats may be applied onto the surface of the polymeric film, the substrate and/or any applied films, e.g., superjacent to protective transitional films.

When the protective film is chosen from protective sheet materials, it may be chosen from, for example, the protective polymeric sheet materials disclosed in paragraphs [0118] to [0126] of U.S. Patent Publication 2004/0096666.

The protective gradient films provide an at least partially abrasion resistant film and may be subsequently coated with another protective film. The protective gradient film may serve to protect the article during shipping or subsequent handling prior to the application of the additional protective film. After application of an additional protective film, the protective gradient film provides a gradient in hardness from one applied film to another. The hardness of such films may be determined by methods known to those skilled in the art. In another non-limiting embodiment, a protective film is superjacent to a protective gradient film. Non-limiting examples of protective films providing such gradient properties include the radiation cured (meth)acrylate-based coatings described in U.S. Patent Application Publication 2003/0165686 in paragraphs [0010] to [0023] and [0079] to [0173], incorporated herein by reference.

The protective films also may include protective coatings. Examples of protective coatings known in the art that provide abrasion and scratch resistance can be chosen from polyfunctional acrylic hard coatings, melamine-based hard coatings, urethane-based hard coatings, alkyd-based coatings and/or organosilane type coatings. Non-limiting examples of such abrasion resistant coatings are disclosed in U.S. Patent Application 2004/0096666 in paragraphs [0128] to [0149], and in U.S. Patent Application 2004/0207809 in paragraphs [0205] to [0249], both disclosures incorporated herein by reference.

In another embodiment, the optical article further comprises an at least partially antireflective surface treatment. The phrase “an at least partially antireflective surface” treatment means that there is an at least partial improvement in the antireflective nature of the optical article to which it is applied. In non-limiting embodiments, there may be a reduction in the amount of glare reflected by the surface of the treated optical article and/or an increase in the percent transmittance through the treated optical article as compared to an untreated optical article.

In another non-limiting embodiment, an at least partially antireflective surface treatment, e.g., a monolayer or multilayer of metal oxides, metal fluorides, or other such materials, can be connected to the surface of the optical articles, e.g., lenses, of the present invention through vacuum evaporation, sputtering, or some other method.

The optical article of the present invention may further comprise an at least partially hydrophobic surface treatment. The phrase “an at least partially hydrophobic surface” is a film that at least partially improves the water repellent nature of the substrate to which it is applied by reducing the amount of water from the surface that can adhere to the substrate as compared to an untreated substrate.

The present invention is more particularly described in the following examples that are intended as illustration only, since numerous modifications and variations therein will be apparent to those skilled in the art.

### EXAMPLES

### Example 1

Whereas particular embodiments of this invention have been described above for purposes of illustration, it will be evident to those skilled in the art that numerous variations of the details of the present invention may be made without departing from the invention as defined in the appended claims.

### Example 1

### Preparation of TRIVEX® AH Resin Castina Solution

Into a suitable glass container equipped with a mixer, Charge 1 was added in the order indicated with mixing. Into another suitable glass equipped with a mixer, Charge 2 was added in the order indicated with mixing. Into a different glass container was added with mixing 3.8 parts of Charge 1 and 1 part of Charge 2.

CHARGE 1

| Material | Weight (grams) |
|---|---|
| TRIVEX ® AH resin⁽¹⁾ | 106.70 |
| Methyl Ethyl Ketone | 120.78 |
| (MEK) | |
| EXALITE ® Blue 7813 | 1.32 |
| Dye Solution⁽²⁾ | |
| BYK ®-377 Solution⁽³⁾ | 0.85 |

⁽¹⁾TRIVEX ® AH resin available commercially from PPG Industries, Inc. was maintained at 65° C. for 2 hours prior to use.
⁽²⁾EXALITE ® Blue 7813 Dye Solution was prepared by adding 0.1241 gram of EXALITE ® Blue 7813 dye, from Exciton to 11.6852 grams of MEK and mixing.
⁽³⁾BYK ®-377 Solution was prepared by the addition of 1.0 gram of BYK ®-377 reported to be a polyether modified polydimethylsiloxane from BYK-Chemie to 9.0 grams of MEK and mixing.

CHARGE 2

| Material | Weight (grams) |
|---|---|
| Diethyl toluene diamine | 24.29 |
| Methyl Ethyl Ketone | 35.53 |
| (MEK) | |
| BYK ®-377⁽³⁾ | 0.22 |

### Example 2

### Preparation of TRIVEX® AY Resin Casting Solution

The procedure of Example 1 was followed except that the materials in Charges 1 and 2 were as follows:

CHARGE 1

| Material | Weight (grams) |
|---|---|
| TRIVEX ® AY resin⁽⁴⁾ | 5.60 |
| Methyl Ethyl Ketone | 6.34 |
| (MEK) | |
| BYK ®-307 Solution⁽⁵⁾ | 0.089 |

⁽⁴⁾TRIVEX ® AY resin available commercially from PPG Industries, Inc. was maintained at 65° C. for 2 hours prior to use.
⁽⁵⁾BYK ®-307 Solution was prepared by the addition of 1.0 gram of BYK ®-307 reported to be a polyether modified polydimethylsiloxane from BYK-Chemie to 9.0 grams of MEK and mixing.

CHARGE 2

| Material | Weight (grams) |
|---|---|
| Diethyl toluene diamine | 1.19 |
| Methyl Ethyl Ketone | 1.86 |
| (MEK) | |
| BYK ®-307⁽⁵⁾ | 0.023 |

### Example 3

### Preparation of TRIVEX® AH Resin Casting Solution

Into a suitable glass container equipped with a mixer, Charge 1 was added in the order indicated with mixing. Into another suitable glass equipped with a mixer, Charge 2 was added in the order indicated with mixing. Into a different glass container was added with mixing 3.8 parts of Charge 1 and 1 part of Charge 2.

CHARGE 1

| Material | Weight (grams) |
|---|---|
| TRIVEX ® AH resin⁽¹⁾ | 5.00 |
| Methylene chloride | 9.32 |
| BYK ®-377 Solution⁽⁶⁾ | 0.0398 |

⁽⁶⁾BYK ®-377 Solution was prepared by the addition of 3.0 gram of BYK ®-377 reported to be a polyether modified polydimethylsiloxane from BYK-Chemie to 27.0 grams of methylene chloride and mixing.

CHARGE 2

| Material | Weight (grams) |
|---|---|
| Diethyl toluene diamine | 1.30 |
| Methylene chloride | 3.12 |
| BYK ®-377⁽⁷⁾ | 0.0102 |
| ZELEC ® UN solution⁽⁷⁾ | 0.0630 |

⁽⁷⁾ZELEC ® UN solution was prepared by adding 0.94 gram of ZELEC ® UN mold release agent to 17.86 grams of methylene chloride and mixing.

### Example 4

### Casting and Testing of Films

Step 1—Film Casting

A GARDCO® Automatic Drawdown Machine (Gardner Co. Inc.) was used. It was equipped with a Microfilm Applicator and a glass plate measuring 30 inches by 45 inches (76.2 centimeters (cm) by 114.3 cm). The gauge of the Microfilm Applicator was set at 11 microns. Approximately 10 to 15 grams of the combination of 3.8 parts of Charge 1 and 1 part of Charge 2 was poured onto the glass plate and the machine was turned on for Examples 1 and 2 and 3.2 parts of Charge 1 to 1 part of Charge 2 for Example 3. The resulting coated glass plate was put into a 70° C. oven and during a time interval of 20 to 25 minutes the temperature was increased to 190° C. for Examples 1 and 2 and for Example 3, the initial oven temperature was 45° C. and the other conditions were the same. The temperature was maintained at 190° C. for 20 to 25 minutes. The coated glass plate was removed and allowed to cool to ambient temperature and the film was removed from the plate.

Step 2—Film Testing

The films prepared in Step 1 of Examples 1 and 2 were tested for the various properties listed in Table 1. The Comparative Example is triacetyl cellulose (TAC) obtained from Fujifilm Corp. The result listed for the Density of the Comparative Example was taken from a publication and the other properties of the Comparative Example were measured as described below. The results for the testing of Example 3 are listed in Table 2.

TABLE 1
Physical Properties of Examples 1 and 2 and Comparative Example

| | | | COMPARATIVE |
|---|---|---|---|
| | EXAMPLE 1 | EXAMPLE 2 | EXAMPLE |
| Property | Trivex AH 107A | Trivex AY 064A | TAC |
| Birefringence (6) | 0 (XY), 0 (Z) | 0 (XY) 4.65 × 10⁻⁴ (Z) | 0 (XY), 5.31 × 10⁻⁴ (Z) |
| Ave Ref. Index (7) | — | 1.52628 | 1.48763 |
| Tensile Strength (MPa) (8) | 73 | 66 | 173 |
| Elongation at break, % (8) | 44 | 109 | 11 |
| Young's Modulus (GPa) (8) | 2.4 | 1.8 | 6.6 |
| Density (g/cm³) (9) | 1.11 | 1.11 | 1.27-1.29 |
| Transmittance (%) (10) | 93.1 | 92.9-93.5 | 94.0 |
| Haze (10) | 0.-0.2 | 0.24-0.70 | 0.38-0.67 |
| Thickness (mil) (11) | ˜3 | ˜3 | ˜3 |
| Tg (° C.) (12) | 192 | 211 | 106 |
| Scratch Resistance (Steel Wood, Δ Haze) | 10.7% | 28.3% | 43.8% |
| (13) | | | |
| Scratch Resistance (Bayer, Δ Haze) (14) | 41.3% | 34.4% | 66.7% |
| L a* b* (15) | 90.39, −0.13, 0.42 | 91.15, −0.08, 0.58 | 92.45, −0.19, 0.57 |
| Chemical Resistance (acetone) (16) | 0 | 0 | 20 |
| coefficient of thermal expansion 25-70C | 93 | 138 | 30 |
| (17) | | | |
| coefficient of thermal expansion 100-140C | 194 | 1220 | 75 |
| (17) | | | |
| Moisture permeability (18) | — | 35 grams of water | 470 grams of water vapor |
| | | vapor/m²/day | /m²/day |

| | |
|---|---|
| (6) | Birefringence values were determined by means of an Optical Bench (Model L305 |
| | from Gaertner Scientific Co.) mounted with a rotating stage and a 7-order babinet |
| | compensator (Model 617-F from Gaertner Scientific Co.). |
| | The in-plane birefringence (Δn₁₂) reported as (XY) was directly obtained with the TD |
| | (transverse direction of casting) axis vertical to the beam path and the ND (normal |
| | direction or thickness direction of the film) axis parallel to the beam path. An out of |
| | plane birefringence (Δn₁₃) reported as (Z) was calculated at various rotations of the |
| | MD (machine casting direction) axis about the vertical TD from the path of light using |
| | the flowing equations. |
| | $Δ {n}_{12} = - \frac{{λ}_{o} {R}_{o}^{*}}{{d}_{o}}$ |
| | $Δ {n}_{13} = - \frac{{λ}_{o}}{Δ {n}_{13}} [ \frac{{R}_{0} - {{R}_{φ} ( 1 - {sin}^{2} φ / {\overline{n}}^{2} )}^{1 / 2}}{{φ}^{2} / {\overline{n}}^{2}} ]$ ${Δn}_{23} =$ |
| | Where: |
| | λ₀: wave length of incident light |
| | d₀: sample thickness |
| | \check{n}: average refractive index of the material |
| | φ: tilting angle |
| | R₀: Retardation of the film from the un-tilted measurement |
| | R_{φ}: Retardation of the film tilted by angle φ |
| | Sample thicknesses were measured by a precision Fouler electronic universal |
| | micrometer. |
| (7) | Average refractive index of the film of Example 2 and the Comparative Example was |
| | determined by an Epic Abbe 60 Refractometer. |
| (8) | Elongation, modulus and stress were measured on an Instron 5543 |
| | Electromechanical Testing machine according to ASTM D1708-06a Standard Test |
| | Method for Tensile Properties of Plastics by Use of Microtensile Specimens. The |
| | results listed are an average of 5 tests. |
| (9) | Density values for both TRIVEX AH & AY were the same. Results for TRIVEX AH |
| | were reported in the TRIVEX ® G2 Lens Material Product Bulletin and reported as |
| | tested by ASTM D792 Standard Test Method for Density and Specific Gravity |
| | (Relative Density) of Plastics by Displacement. The result listed for the Comparative |
| | Example were taken from H. Sata, et al. “Properties and Applications of Cellulose |
| | Triacetate Film”, Macromol. Symp. 2004, 208, 323-333. |
| (10) | Transmittance and haze were measured on a Garder Hazegard Plus instrument |
| | according to manufacturer's instructions. |
| (11) | Sample thicknesses were measured by a precision Fowler electronic universal |
| | micrometer. The results listed are an average of 5 measurements. |
| (12) | All of the samples were analyzed with a TA Instruments 2920 DSC at 25° C./min to |
| | 300° C. in covered aluminum hermetic pans. The nitrogen purge rate was 50 mL/min. |
| | The DSC was calibrated with indium and tin standards. The peak area was calculated |
| | using a sigmoidal baseline. This procedure generally followed ASTM D3419-03 |
| | Standard Test Method for Transition Temperatures and Enthalpies of Fusion and |
| | Crystallization of Polymers by Differential Scanning Calorimetry. |
| (13) | Steel Wool Test according to the Steel Wool Abrasion - SOP#L-11-12-05 of the |
| | COLTS ® Laboratories except that the results reported represent the difference in |
| | percent haze between the initial and final percent haze of the test sample. The results |
| | listed are an average of 2 tests. |
| (14) | Bayer abrasion resistance according to the Bayer Test - SOP#L-11-10-06 of the |
| | COLTS ® Laboratories. The results listed are an average of 2 tests. |
| (15) | Percent transmission (L), a* (redness-greenness) and b* (yellowness-blueness) |
| | values were determined in accordance with ASTM D 1925-70, using a Hunter Lab |
| | model D25P-9 calorimeter employing a Lumen C light source. Positive a* values |
| | indicate redness, negative a* values indicate greenness, positive b* values indicate |
| | yellowness, and negative b* values indicate blueness. |
| (16) | Chemical resistance was determined using a 2 inch by 2 inch (5.08 cm by 5.08 cm) |
| | sample. A “before” haze value of the sample was measured on the Hazegard Plus |
| | instrument. The sample was immersed in the solvent for 10 minutes at room |
| | temperature. After removal from the solvent, the sample was rinsed with deionized |
| | water and allowed to dry at room temperature. The “after” haze value was |
| | determined. The difference between the “before” and “after” haze values is reported |
| | in the Table. |
| (17) | Coefficient of thermal expansion was determined using a rectangular strip measuring |
| | approximately 20.5 mm by 6 mm mounted onto a TA Instruments DMA Model 2980 in |
| | the controlled force mode. The sample was subjected to heat from 0° C. to 180° C. at |
| | 5° C./ min and 0.2 N force. Data was collected every 4 seconds and the temperature |
| | was calibrated accordingly. |
| (18) | Moisture permeability was measured using a MOCON Permatran W-6 Programmable |
| | Water Vapor Permeability Tester and the test was performed at 37.8° C. The general |
| | type of test method is described in ASTM F1249-06 “Standard Test Method for Water |
| | Vapor Transmission Rate Through Plastic Film and Sheeting Using a Modulated |
| | Infrared Sensor” except that the MOCON Permatran W-6 was used. |

The results of Table 1 illustrate that the films of Examples 1 and 2 demonstrated improved properties over the film of the Comparative Example. Both of the films of Examples 1 and 2 had a lower birefringence; elongation was higher and Young's modulus was lower indicating better mechanical properties; the scratch resistance showed a lower difference in percent haze; and the coefficient of thermal expansion and the glass transition temperatures were higher. The film of Example 2 had better chemical resistance to acetone that the Comparative Example as shown by a lower difference in percent haze; and a lower value for the Moisture permeability test.

TABLE 2
Physical Properties of Example 3

| | EXAMPLE 3 |
|---|---|
| Property | Trivex AH 0410 |
| Tensile Strength (MPa) (8) | 65.4 |
| Elongation at break, % (8) | 39 |
| Young's Modulus (GPa) (8) | 1.1 |
| Transmittance (%) (10) | 91.4 |
| Haze (10) | 0.0 |
| Thickness (mil) (11) | 3.26-4.45 |
| L a* b* (15) | 96.62, −0.08, 0.41 |

The present invention has been described with reference to specific details of particular embodiments thereof. It is not intended that such details be regarded as limitations upon the scope of the invention except insofar as and to the extent that they are included in the accompanying claims.

What is claimed is:

1. A method of preparing a cured, non-elastomeric polyurethane-containing film comprising:
a) providing a first component comprising a polyurethane material having isocyanate functional groups;
b) providing a second component comprising a material having active hydrogen-containing functional groups that are reactive with isocyanate;
c) combining the first and second components to form a reaction mixture;
d) casting the reaction mixture onto a support substrate in a substantially uniform thickness to form a film thereon;
e) heating the film on the support substrate to a temperature and for a time sufficient to yield a cured film; and
f) removing the cured film from the support substrate to yield a non-elastomeric polyurethane-containing free film, which is non-birefringent.

2. The method of claim 1 wherein the first component further comprises a solvent.

3. The method of claim 2 wherein the solvent is present in the first component in an amount of 20 to 80 percent by weight, based on the total weight of the first component.

4. The method of claim 1 wherein the second component further comprises a solvent.

5. The method of claim 4 wherein the solvent is present in the second component in an amount of 20 to 80 percent by weight, based on the total weight of the second component.

6. The method of claim 1 wherein the reaction mixture further comprises a surfactant.

7. The method of claim 1 wherein the reaction mixture further comprises a catalyst.

8. The method of claim 1 wherein the isocyanate functional groups on the material in the first component are at least partially capped.

9. The method of claim 1 wherein the material having isocyanate functional groups in the first component has a number average molecular weight of up to 1000.

10. The method of claim 1 wherein the material having isocyanate functional groups in the first component has a number average molecular weight of greater than 1000.

11. The method of claim 1 wherein the material having active hydrogen-containing functional groups in the second component comprises diethylene toluenediamine, methylene dianiline, methyl diisopropyl aniline, methyl diethyl aniline, trimethylene glycol di-para aminobenzoate, 4,4′-methylene-bis(2,6-diisopropylaniline), 4,4′-methylene-bis(2,6-dimethylaniline), 4,4′-methylene-bis(2-ethyl-6-methylaniline), 4,4′-methylene-bis(2,6-diethylaniline), 4,4′-methylene-bis(2-isopropyl-6-methylaniline), and/or 4,4′-methylene-bis(2,6-diethyl-3-chloroaniline).

12. The method of claim 1 wherein the dry film thickness of the cured free film formed in step (f) is 0.5 to 20 mils (12.7 to 508 microns).

13. The method of claim 1 wherein the film is heated in step (e) to a temperature of 100 to 210° C. for a period of 10 to 100 minutes.

14. The method of claim 1 wherein the film is heated in step (e) to a temperature of 25 to 100° C. for a period of 100 minutes to five days.

15. A polarizing optical element comprising, in combination:
a) a polarizing film layer having two opposed surfaces; and
b) a protective, supportive layer comprising a cured, non-elastomeric polyurethane-containing film appended to at least one of the opposed surfaces of the polarizing film layer.

16. The optical element of claim 15 wherein the polarizing film layer comprises a polymeric material that has been stretched and impregnated with an iodine chromophore or dichroic dye.

17. The optical element of claim 16 wherein the polymeric material comprises polyvinyl alcohol.

18. The optical element of claim 15 wherein the cured, non-elastomeric polyurethane-containing film is non-birefringent.

19. The optical element of claim 15 wherein the polarizing film layer and the supportive layers are adhered to each other with a pressure-sensitive adhesive.

20. The optical element of claim 15 wherein the polarizing film layer and the supportive layers are adhered to each other by surface treatment of the polarizing film layer and/or the supportive layers prior to assembly of the optical element.

21. The optical element of claim 15 wherein the thickness of the polarizing film layer in the element is from 0.1 to 10 mils (2.54 to 254 microns).

22. The optical element of claim 15, wherein the polarizing film layer is positioned between two protective, supportive layers comprising a cured, non-elastomeric polyurethane-containing film.

23. The optical element of claim 15, further comprising a removable protective layer superposed on at least one supportive layer.

24. The optical element of claim 15 wherein the cured, non-elastomeric polyurethane-containing film is prepared by the method of claim 1.

25. An optical article comprising, in combination:
a) a substrate; and
b) a polarizing optical element appended to at least one surface of the substrate, the polarizing optical element comprising, in combination:
i) a polarizing film layer having two opposed surfaces; and
ii) a protective, supportive layer comprising a cured, non-elastomeric polyurethane-containing film appended to at least one of the opposed surfaces of the polarizing film layer.

26. The optical article of claim 25, wherein the polarizing optical element is superposed on at least one surface of the substrate.

27. The optical article of claim 25, wherein the polarizing film layer is positioned between two protective, supportive layers comprising a cured, non-elastomeric polyurethane-containing film.

28. The optical article of claim 25 wherein the substrate comprises mineral glass, ceramic material and/or polymeric organic material.

29. The optical article of claim 25 wherein the substrate comprises a display, screen, lens, windshield, ophthalmic article, or glazing.

30. The optical article of claim 25, further comprising at least one film or coating positioned as an intervening layer between the substrate and the polarizing optical element.

31. The optical article of claim 27, wherein the intervening layer comprises a retardation film.

32. The optical article of claim 25, further comprising at least one film and/or at least one coating superposed on the polarizing optical element.

33. The optical article of claim 32, wherein the superposed film or coating comprises an abrasion resistant coating.

34. The optical article of claim 25, wherein the optical article comprises a component of a liquid crystal display.
